(19) United States
(12) Patent Application Publication
(10) Pub. No.: US 2020/0349376 A1
(43) Pub. Date: Nov. 5, 2020

(54) PRIVACY AUGMENTATION USING COUNTER RECOGNITION

(71) Applicant: QUALCOMM Incorporated, San Diego, CA (US)

(72) Inventor: Vijayalakshmi RAVEENDRAN, Del Mar, CA (US)

(21) Appl. No.: 16/401,035

(22) Filed: May 1, 2019

(51) Int. Cl. G06K 9/20; G06K 9/00; H04N 5/232

(52) U.S. Cl. CPC G06K 9/2081; G06K 9/00771; G06K 9/2036; H04N 5/23203; G06K 9/00288

(57) ABSTRACT

Techniques and systems are provided for performing one or more counter recognition techniques. For example, an incident signal can be received by a user device, and one or more signal parameters of the incident signal can be determined. Based on the one or more signal parameters of the incident signal, one or more response signals can be transmitted to prevent object recognition (e.g., face recognition) of a user by the camera.

### FIELD

The present disclosure generally relates to techniques and systems providing privacy augmentation using counter recognition.

### BACKGROUND

Many venues include surveillance systems with cameras that can detect, track, and/or recognize people. For example, a camera can include a biometric-based system used to detect and/or recognize an object. An example of a biometric-based system includes face detection and/or recognition. Face recognition, for example, can compare facial features of a person in an input image with a database of features of various known people, in order to recognize who the person is. A surveillance system can provide security to a venue, but also introduces privacy concerns for the people under surveillance.

### SUMMARY

Systems and techniques are described herein that provide privacy augmentation using counter recognition. For instance, the counter recognition techniques can provide user privacy from one or more cameras by preventing the one or more cameras from successfully performing face recognition. In some examples, the counter recognition can be implemented using a wearable device that includes the signal processing and power to perform the counter recognition techniques. Any suitable wearable device can be used to perform the counter recognition techniques described herein, such as glasses worn on a user's face, a hat, or other suitable wearable device. In some examples, the counter recognition can be implemented using a user device other than a wearable device, such as a mobile device, mobile phone, tablet, or other user device.

The systems and techniques can perform one or more counter recognition techniques in response to receiving and/or detecting one or more incident signals. Receiving an incident signal can include receiving an infrared signal, a near-infrared signal, an image signal (e.g., a red-green-blue (RGB) image signal), any suitable combination thereof, or receiving another type of signal. If an incident signal meets certain criteria, a counter recognition technique can be performed in order to prevent face recognition from being successfully performed. In some cases, multiple counter recognition techniques can be available for use by the wearable device. The wearable device can choose which counter recognition technique(s) to apply based on characteristics of the incident signal. For instance, different counter recognition techniques can be performed based on the type of signal (e.g., an infrared signal, near-infrared signal, visible light or image signal, etc.).

One illustrative example of a counter recognition technique includes a jamming counter recognition technique that can prevent face recognition from being performed by a camera. For instance, one or more light sources of the wearable device can emit response signals back towards a camera to jam incident signals emitted from the camera. A response signal can include an inverse signal having the same amplitude and frequency as an incident signal, and having an inverse of the phase of the incident signal.

Another illustrative example of a counter recognition technique includes a masking counter recognition technique. For example, the one or more light sources of the wearable device can direct light signals onto targeted face landmarks that are used for face recognition by a camera. The light signals add noise to the face landmarks, effectively distorting face recognition from the one or more surveillance cameras. In some cases, the light signals can be adapted to lighting conditions (e.g., extraneous incident light, ambient light, and/or other lighting conditions).

In one illustrative example, a method of preventing face recognition by a camera is provided. The method includes receiving, by a user device, an incident signal. The method further includes determining one or more signal parameters of the incident signal. The method further includes transmitting, based on the one or more signal parameters of the incident signal, one or more response signals, the one or more response signals preventing face recognition of a user by the camera.

In another example, an apparatus for preventing face recognition by a camera is provided that includes a memory and a processor coupled to the memory. In some examples, more than one processor can be coupled to the memory. The processor is configured to store information, such as one or more signal parameters of incident signals, parameters of response signals, among other information. The processor is configured to and can receive an incident signal. The processor is further configured to and can determine one or more signal parameters of the incident signal. The processor is further configured to and can transmit, based on the one or more signal parameters of the incident signal, one or more response signals, the one or more response signals preventing face recognition of a user by the camera.

In another example, a non-transitory computer-readable medium is provided that has stored thereon instructions that, when executed by one or more processors, cause the one or more processor to: receive an incident signal; determine one or more signal parameters of the incident signal; and transmit, based on the one or more signal parameters of the incident signal, one or more response signals, the one or more response signals preventing face recognition of a user by the camera.

In another example, an apparatus for preventing face recognition by a camera is provided. The apparatus includes means for receiving an incident signal. The apparatus further includes means for determining one or more signal parameters of the incident signal. The apparatus further includes means for transmitting, based on the one or more signal parameters of the incident signal, one or more response signals, the one or more response signals preventing face recognition of a user by the camera.

In some aspects, the incident signal is from the camera.

In some aspects, transmitting the one or more response signals includes transmitting the one or more response signals in a direction towards the camera. In some aspects, transmitting the one or more response signals includes projecting the one or more response signals to one or more face landmarks of the user.

In some aspects, the method, apparatuses, and computer-readable medium described above further comprise detecting the incident signal, and estimating one or more inverse signal parameters associated with the one or more signal parameters of the incident signal. In such aspects, transmitting, based on the one or more signal parameters of the incident signal, the one or more response signals includes transmitting, towards the camera, at least one inverse signal having the one or more inverse signal parameters. The at least one inverse signal at least partially cancels out one or more incident signals. In some implementations, the one or more signal parameters include an amplitude, a frequency, and a phase of the incident signal, and the one or more inverse signal parameters include at least a fraction of the amplitude, the frequency, and an inverse of the phase.

In some aspects, the method, apparatuses, and computer-readable medium described above further comprise estimating one or more noise signal parameters based on the one or more signal parameters of the incident signal. In such aspects, transmitting, based on the one or more signal parameters of the incident signal, the one or more response signals includes projecting one or more noise signals having the one or more noise signal parameters to one or more face landmarks of the user. The one or more noise signal parameters cause the one or more noise signals to match one or more characteristics of the one or more face landmarks of the user. In some implementations, the one or more noise signal parameters include at least one of a contrast, a color temperature, a brightness, a number of lumens, or a light pattern.

In some aspects, the method, apparatuses, and computer-readable medium described above further comprise determining whether the incident signal is a first type of signal or a second type of signal. In some cases, the first type of signal includes an infrared signal, and the second type of signal includes a visible light spectrum signal having one or more characteristics. In some cases, the first type of signal includes a near-infrared signal, and the second type of signal includes a visible light spectrum signal having one or more characteristics. In some cases, the first type of signal includes an infrared signal, and the second type of signal includes a near-infrared signal.

In some aspects, transmitting, based on the one or more signal parameters of the incident signal, the one or more response signals includes transmitting the one or more response signals in a direction towards the camera when the incident signal is determined to be the first type of signal. In some implementations, the method, apparatuses, and computer-readable medium described above further comprise estimating one or more inverse signal parameters associated with the one or more signal parameters of the incident signal. In such implementations, transmitting, based on the one or more signal parameters of the incident signal, the one or more response signals includes transmitting, towards the camera, at least one inverse signal having the one or more inverse signal parameters. The at least one inverse signal at least partially cancels out one or more incident signals.

In some aspects, transmitting, based on the one or more signal parameters of the incident signal, the one or more response signals includes projecting the one or more response signals to one or more face landmarks of the user when the incident signal is determined to be the second type of signal. In some implementations, the method, apparatuses, and computer-readable medium described above further comprise estimating one or more noise signal parameters based on the one or more signal parameters of the incident signal. In such implementations, transmitting, based on the one or more signal parameters of the incident signal, the one or more response signals includes projecting one or more noise signals having the one or more noise signal parameters to one or more face landmarks of the user. The one or more noise signal parameters cause the one or more noise signals to match one or more characteristics of the one or more face landmarks of the user. In some examples, the one or more noise signal parameters include at least one of a contrast, a color temperature, a brightness, a number of lumens, or a light pattern.

In some aspects, the method, apparatuses, and computer-readable medium described above further comprise providing an indication to the user that face recognition was attempted. In some cases, the method, apparatuses, and computer-readable medium described above further comprise: receiving input from a user indicating a preference to approve performance of the face recognition; and ceasing from transmitting the one or more response signals in response to receiving the input. In some examples, the method, apparatuses, and computer-readable medium described above further comprise saving the preference.

In some aspects, the apparatus comprises a wearable device. In some aspects, the apparatus comprises a mobile device (e.g., a mobile telephone or so-called “smart phone”). In some aspects, the apparatus further includes at least one of a camera for capturing one or more images, an infrared camera, or an infrared illuminator. For example, the apparatus can include a camera (e.g., an RGB camera) for capturing one or more images, an infrared camera, and an infrared illuminator. In some aspects, the apparatus further includes a display for displaying one or more images, notifications, or other displayable data.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and embodiments, will become more apparent upon referring to the following specification, claims, and accompanying drawings.

### BRIEF DESCRIPTION OF THE DRAWINGS

Illustrative embodiments of the present application are described in detail below with reference to the following figures:

FIG. 1A is a block diagram illustrating an example of an object recognition system, in accordance with some examples;

FIG. 1B is a diagram illustrating an intersecting relationship between two bounding boxes, in accordance with some examples;

FIG. 2 is a block diagram illustrating a counter recognition system for performing counter recognition, in accordance with some examples;

FIG. 3A is a conceptual diagram illustrating an example configuration of components of the counter recognition system, in accordance with some examples;

FIG. 3B is a conceptual diagram illustrating another example configuration of components of the counter recognition system, in accordance with some examples;

FIG. 4 is a flowchart illustrating an example of a process for selecting a counter recognition technique, in accordance with some examples; and

FIG. 5 is an image illustrating an example of a jamming counter recognition technique, in accordance with some examples;

FIG. 6A is a diagram illustrating an example of an incident signal and a response signal having a phase that is the inverse of the phase of the incident signal, in accordance with some examples;

FIG. 6B is a conceptual diagram illustrating examples of incident signals and response signals that can be used in a jamming counter recognition technique, in accordance with some examples;

FIG. 6C is a conceptual diagram illustrating other examples of incident signals and response signals that can be used in a jamming counter recognition technique, in accordance with some examples;

FIG. 7 is an image illustrating an example of a masking counter recognition technique, in accordance with some examples;

FIG. 8 is a flowchart illustrating an example of a masking counter recognition process, in accordance with some examples;

FIG. 9A, FIG. 9B, and FIG. 9C are images illustrating an example of ranking face landmarks for a masking counter recognition technique, in accordance with some examples;

FIG. 10 is an image illustrating an example implementation of a masking counter recognition technique, in accordance with some examples;

FIG. 11 is a flowchart illustrating an example of a process of preventing face recognition by a camera, in accordance with some examples; and

FIG. 12 illustrates an example computing device architecture of an example computing device which can implement the various techniques described herein.

### DETAILED DESCRIPTION

Certain aspects and embodiments of this disclosure are provided below. Some of these aspects and embodiments may be applied independently and some of them may be applied in combination as would be apparent to those of skill in the art. In the following description, for the purposes of explanation, specific details are set forth in order to provide a thorough understanding of embodiments of the application. However, it will be apparent that various embodiments may be practiced without these specific details. The figures and description are not intended to be restrictive.

The ensuing description provides exemplary embodiments only, and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the application as set forth in the appended claims.

Specific details are given in the following description to provide a thorough understanding of the embodiments. However, it will be understood by one of ordinary skill in the art that the embodiments may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Also, it is noted that individual embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

Furthermore, embodiments may be implemented by hardware, software, firmware, middleware, microcode, hardware description languages, or any combination thereof. When implemented in software, firmware, middleware or microcode, the program code or code segments to perform the necessary tasks (e.g., a computer-program product) may be stored in a computer-readable or machine-readable medium. A processor(s) may perform the necessary tasks.

Object recognition (also referred to as object identification) can be performed to recognize certain objects. Some object recognition systems are biometric-based. Biometrics is the science of analyzing physical or behavioral characteristics specific to an individual, in order to be able to determine the identity of each individual. Object recognition can be defined as a one-to-multiple problem in some cases. Face recognition is an example of a biometric-based object recognition. For example, face recognition (as an example of object recognition) can be used to find a person (one) from multiple persons (many). Face recognition has many applications, such as for identifying a person from a crowd, performing a criminal search, among others. Object recognition can be distinguished from object authentication, which is a one-to-one problem. For example, face authentication can be used to check if a person is who they claim to be (e.g., to check if the person claimed is the person in an enrolled database of authorized users).

Using face recognition as an illustrative example of object recognition, an enrolled database containing the features of enrolled faces can be used for comparison with the features of one or more given query face images (e.g., from input images or frames). The enrolled faces can include faces registered with the system and stored in the enrolled database, which contains known faces. An enrolled face that is the most similar to a query face image can be determined to be a match with the query face image. Each enrolled face can be associated with a person identifier that identifies the person to whom the face belongs. The person identifier of the matched enrolled face (the most similar face) is identified as the person to be recognized.

Biometric-based object recognition systems can have at least two steps, including an enrollment step and a recognition step (or test step). The enrollment step captures biometric data of various persons, and stores representations of the biometric data as templates. The templates can then be used in the recognition step. For example, the recognition step can determine the similarity of a stored template against a representation of input biometric data corresponding to a person, and can use the similarity to determine whether the person can be recognized as the person associated with the stored template.

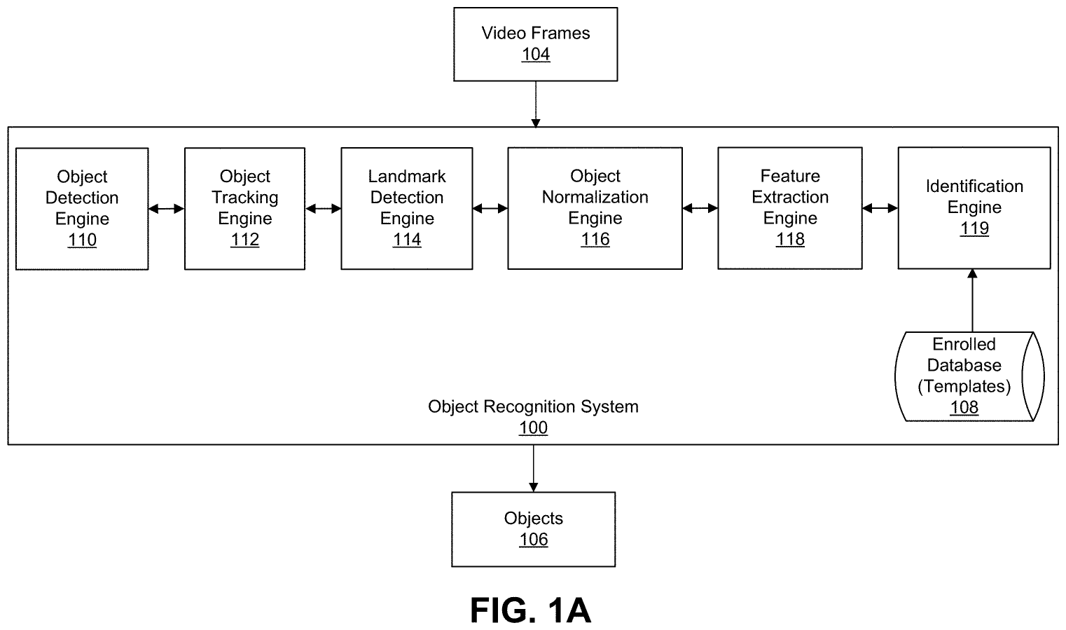

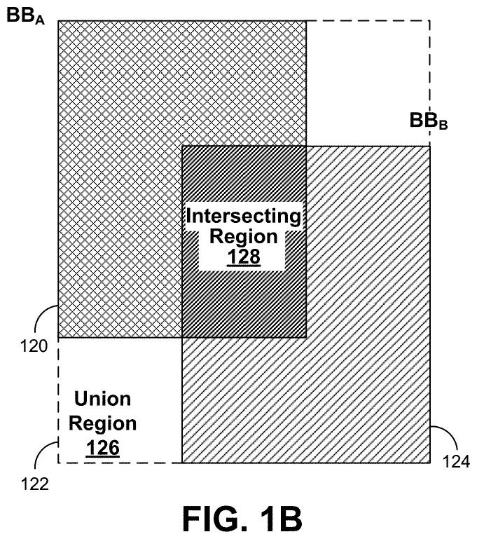

FIG. 1A is a diagram illustrating an example of an object recognition system 100 that can perform object recognition using images captured using visible light. The object recognition system 100 can be part of a camera. The camera can include other components not shown in FIG. 1A, such as imaging optics, one or more transmitters, one or more receivers, one or more processors, among other components. The object recognition system 100 can be implemented using the one or more processors of the camera. The object recognition system 100 processes video frames 104 and outputs objects 106 as detected, tracked, and/or recognized objects. The object recognition system 100 can perform any type of object recognition. An example of object recognition performed by the object recognition system 100 includes face recognition. However, one of ordinary skill will appreciate that any other suitable type of object recognition can be performed by the object recognition system 100. One example of a full face recognition process for recognizing objects in the video frames 104 includes performing object detection, object tracking, object landmark detection, object normalization, feature extraction, and identification (also referred to as recognition) and/or verification (also referred to as authentication). Object recognition can be performed using some or all of these steps, with some steps being optional in some cases.

The object recognition system 100 includes an object detection engine 110 that can perform object detection. In one illustrative example, the object detection engine 110 can perform face detection to detect one or more faces in a video frame. Object detection is a technology to identify objects from an image or video frame. For example, face detection can be used to identify faces from an image or video frame. Many object detection algorithms (including face detection algorithms) use template matching techniques to locate objects (e.g., faces) from the images. Various types of template matching algorithms can be used. In other object detection algorithm can also be used by the object detection engine 110.

One example template matching algorithm contains four steps, including Haar feature extraction, integral image generation, Adaboost training, and cascaded classifiers. Such an object detection technique performs detection by applying a sliding window across a frame or image. For each current window, the Haar features of the current window are computed from an Integral image, which is computed beforehand. The Haar features are selected by an Adaboost algorithm and can be used to classify a window as a face (or other object) window or a non-face window effectively with a cascaded classifier. The cascaded classifier includes many classifiers combined in a cascade, which allows background regions of the image to be quickly discarded while spending more computation on object-like regions. For example, the cascaded classifier can classify a current window into a face category or a non-face category. If one classifier classifies a window as a non-face category, the window is discarded. Otherwise, if one classifier classifies a window as a face category, a next classifier in the cascaded arrangement will be used to test again. Until all the classifiers determine the current window is a face, the window will be labeled as a candidate of face. After all the windows are detected, a non-max suppression algorithm is used to group the face windows around each face to generate the final result of detected faces. Further details of such an object detection algorithm is described in P. Viola and M. Jones, “Robust real time object detection,” IEEE ICCV Workshop on Statistical and Computational Theories of Vision, 2001, which is hereby incorporated by reference, in its entirety and for all purposes.

Other suitable object detection techniques could also be performed by the object detection engine 110. One illustrative example of object detection includes an example-based learning for view-based face detection, such as that described in K. Sung and T. Poggio, “Example-based learning for view-based face detection,” IEEE Patt. Anal. Mach. Intell., volume 20, pages 39-51, 1998, which is hereby incorporated by reference, in its entirety and for all purposes. Another example is neural network-based object detection, such as that described in H. Rowley, S. Baluja, and T. Kanade, “Neural network-based face detection,” IEEE Patt. Anal. Mach. Intell., volume 20, pages 22-38, 1998., which is hereby incorporated by reference, in its entirety and for all purposes. Yet another example is statistical-based object detection, such as that described in H. Schneiderman and T. Kanade, “A statistical method for 3D object detection applied to faces and cars,” International Conference on Computer Vision, 2000, which is hereby incorporated by reference, in its entirety and for all purposes. Another example is a snowbased object detector, such as that described in D. Roth, M. Yang, and N. Ahuja, “A snowbased face detector,” Neural Information Processing 12, 2000, which is hereby incorporated by reference, in its entirety and for all purposes. Another example is a joint induction object detection technique, such as that described in Y. Amit, D. Geman, and K. Wilder, “Joint induction of shape features and tree classifiers,” 1997, which is hereby incorporated by reference, in its entirety and for all purposes. Any other suitable image-based object detection technique can be used.

The object recognition system 100 further includes an object tracking engine 112 that can perform object tracking for one or more of the objects detected by the object detection engine 110. In one illustrative example, the object tracking engine 112 can track faces detected by the object detection engine 110. Object tracking includes tracking objects across multiple frames of a video sequence or a sequence of images. For instance, face tracking is performed to track faces across frames or images. The full object recognition process (e.g., a full face recognition process) is time consuming and resource intensive, and thus it is sometimes not realistic to recognize all objects (e.g., faces) for every frame, such as when numerous faces are captured in a current frame. In order to reduce the time and resources needed for object recognition, object tracking techniques can be used to track previously recognized faces. For example, if a face has been recognized and the object recognition system 100 is confident of the recognition results (e.g., a high confidence score is determined for the recognized face), the object recognition system 100 can skip the full recognition process for the face in one or several subsequent frames if the face can be tracked successfully by the object tracking engine 112.

Any suitable object tracking technique can be used by the object tracking engine 112. One example of a face tracking technique includes a key point technique. The key point technique includes detecting some key points from a detected face (or other object) in a previous frame. For example, the detected key points can include significant corners on face, such as face landmarks. The key points can be matched with features of objects in a current frame using template matching. As used herein, a current frame refers to a frame currently being processed. Examples of template matching methods can include optical flow, local feature matching, and/or other suitable techniques. In some cases, the local features can be histogram of gradient, local binary pattern (LBP), or other features. Based on the tracking results of the key points between the previous frame and the current frame, the faces in the current frame that match faces from a previous frame can be located.

Another example object tracking technique is based on the face detection results. For example, the intersection over union (IOU) of face bounding boxes can be used to determine if a face detected in the current frame matches a face detected in the previous frame. FIG. 1B is a diagram showing an example of an intersection I and union U of two bounding boxes, including bounding box BB_{A} 120 of an object in a current frame and bounding box BB_{B} 124 of an object in the previous frame. The intersecting region 128 includes the overlapped region between the bounding box BB_{A} 120 and the bounding box BB_{B} 124.

The union region 126 includes the union of bounding box BB_{A} 120 and bounding box BB_{B} 124. The union of bounding box BB_{A} 120 and bounding box BB_{B} 124 is defined to use the far corners of the two bounding boxes to create a new bounding box 122 (shown as dotted line). More specifically, by representing each bounding box with (x, y, w, h), where (x, y) is the upper-left coordinate of a bounding box, w and h are the width and height of the bounding box, respectively, the union of the bounding boxes would be represented as follows:

Union(BB₁,BB₂)=(min(x₁,x₂),min(y₁,y₂),(max(x₁+w₁−1,x₂+w₂−1)−min(x₁,x₂)),(max(y₁+h₁−1,y₂+h₂−1)−min(y₁,y₂)))

Using FIG. 1B as an example, the bounding box BB_{A} 120 and the bounding box BB_{B} 124 can be determined to match for tracking purposes if an overlapping area between the bounding box BB_{A} 120 and the bounding box BB_{B} 124 (the intersecting region 128) divided by the union 126 of the bounding boxes 120 and 124 is greater than an IOU threshold (denoted as T_{IOU}<Area of Intersecting Region 308/Area of Union 310). The IOU threshold can be set to any suitable amount, such as 50%, 60%, 70%, 75%, 80%, 90%, or other configurable amount. In one illustrative example, the bounding box BB_{A} 120 and the bounding box BB_{B} 124 can be determined to be a match when the IOU for the bounding boxes is at least 70%. The object in the current frame can be determined to be the same object from the previous frame based on the bounding boxes of the two objects being determined as a match.

In another example, an overlapping area technique can be used to determine a match between bounding boxes. For instance, the bounding box BB_{A} 120 and the bounding box BB_{B} 124 can be determined to be a match if an area of the bounding box BB_{A} 120 and/or an area the bounding box BB_{B} 124 that is within the intersecting region 128 is greater than an overlapping threshold. The overlapping threshold can be set to any suitable amount, such as 50%, 60%, 70%, or other configurable amount. In one illustrative example, the bounding box BB_{A} 120 and the bounding box BB_{B} 124 can be determined to be a match when at least 65% of the bounding box 120 or the bounding box 124 is within the intersecting region 128.

In some implementations, the key point technique and the IOU technique (or the overlapping area technique) can be combined to achieve even more robust tracking results. Any other suitable object tracking (e.g., face tracking) techniques can be used. Using any suitable technique, face tracking can reduce the face recognition time significantly, which in turn can save CPU bandwidth and power.

As noted above, a face is tracked over a sequence of video frames based on face detection. For instance, the object tracking engine 112 can compare a bounding box of a face detected in a current frame against all the faces detected in the previous frame to determine similarities between the detected face and the previously detected faces. The previously detected face that is determined to be the best match is then selected as the face that will be tracked based on the currently detected face.

Faces can be tracked across video frames by assigning a unique tracking identifier to each of the bounding boxes associated with each of the faces. For example, the face detected in the current frame can be assigned the same unique identifier as that assigned to the previously detected face in the previous frame. A bounding box in a current frame that matches a previous bounding box from a previous frame can be assigned the unique tracking identifier that was assigned to the previous bounding box. In this way, the face represented by the bounding boxes can be tracked across the frames of the video sequence.

The landmark detection engine 114 can perform object landmark detection. For example, the landmark detection engine 114 can perform face landmark detection for face recognition. Face landmark detection can be an important step in face recognition. For instance, object landmark detection can provide information for object tracking (as described above) and can also provide information for face normalization (as described below). A good landmark detection algorithm can improve the face recognition accuracy significantly, as well as the accuracy of other object recognition processes.

One illustrative example of landmark detection is based on a cascade of regressors method. Using such a method in face recognition, for example, a cascade of regressors can be learned from faces with labeled landmarks. A combination of the outputs from the cascade of the regressors provides accurate estimation of landmark locations. The local distribution of features around each landmark can be learned and the regressors will give the most probable displacement of the landmark from the previous regressor's estimate. Further details of a cascade of regressors method is described in V. Kazemi and S. Josephine, “One millisecond face alignment with an ensemble of regression trees,” CVPR, 2014, which is hereby incorporated by reference, in its entirety and for all purposes. Any other suitable landmark detection techniques can also be used by the landmark detection engine 114.

The object recognition system 100 further includes an object normalization engine 116 for performing object normalization. Object normalization can be performed to align objects for better object recognition results. For example, the object normalization engine 116 can perform face normalization by processing an image to align and/or scale the faces in the image for better recognition results. One example of a face normalization method uses two eye centers as reference points for normalizing faces. The face image can be translated, rotated, and scaled to ensure the two eye centers are located at the designated location with a same size. A similarity transform can be used for this purpose. Another example of a face normalization method can use five points as reference points, including two centers of the eyes, two corners of the mouth, and a nose tip. In some cases, the landmarks used for reference points can be determined from face landmark detection.

In some cases, the illumination of the face images may also need to be normalized. One example of an illumination normalization method is local image normalization. With a sliding window be applied to an image, each image patch is normalized with its mean and standard deviation. The center pixel value is subtracted from the mean of the local patch and then divided by the standard deviation of the local patch. Another example method for lighting compensation is based on discrete cosine transform (DCT). For instance, the second coefficient of the DCT can represent the change from a first half signal to the next half signal with a cosine signal. This information can be used to compensate a lighting difference caused by side light, which can cause part of a face (e.g., half of the face) to be brighter than the remaining part (e.g., the other half) of the face. The second coefficient of the DCT transform can be removed and an inverse DCT can be applied to get the left-right lighting normalization.

The feature extraction engine 118 performs feature extraction, which is an important part of the object recognition process. One illustrative example of a feature extraction process is based on steerable filters. A steerable filter-based feature extraction approach operates to synthesize filters using a set of basis filters. For instance, the approach provides an efficient architecture to synthesize filters of arbitrary orientations using linear combinations of basis filters. Such a process provides the ability to adaptively steer a filter to any orientation, and to determine analytically the filter output as a function of orientation. In one illustrative example, a two-dimensional (2D) simplified circular symmetric Gaussian filter can be represented as:

G(x,y)=e^{-(x}^{²}^{+y}^{²}⁾,

where x and y are Cartesian coordinates, which can represent any point, such as a pixel of an image or video frame. The n-th derivative of the Gaussian is denoted as Gₙ, and the notation ( . . . )^{θ} represents the rotation operator. For example, ƒ^{θ}(x,y) is the function ƒ(x,y) rotated through an angle θ about the origin. The x derivative of G(x,y) is:

G₁^{0°}=∂/∂xG(x,y)=−2xe^{-(x}^{²}^{+y}^{²}⁾,

and the same function rotated 90° is:

G₁^{90°}=∂/∂yG(x,y)=−2ye^{-(x}^{²}^{+y}^{²}⁾,

where G₁^{0°} and G₁^{90°} are called basis filters since G₁^{θ} can be represented as G₁^{θ}=cos(θ)G₁^{0°}+sin(θ)G₁^{90°} and θ is arbitrary angle, indicating that G₁^{0°} and G₁^{90°} span the set of G₁^{θ} filters (hence, basis filters). Therefore, G₁^{0°} and G₁^{90°} can be used to synthesize filters with any angle. The cos(θ) and sin(θ) terms are the corresponding interpolation functions for the basis filters.

Steerable filters can be convolved with face images to produce orientation maps which in turn can be used to generate features (represented by feature vectors). For instance, because convolution is a linear operation, the feature extraction engine 118 can synthesize an image filtered at an arbitrary orientation by taking linear combinations of the images filtered with the basis filters G₁^{0°} and G₁^{90°}. In some cases, the features can be from local patches around selected locations on detected faces (or other objects). Steerable features from multiple scales and orientations can be concatenated to form an augmented feature vector that represents a face image (or other object). For example, the orientation maps from G₁^{0°} and G₁^{90°} can be combined to get one set of local features, and the orientation maps from G₁^{45°} and G₁^{135°} can be combined to get another set of local features. In one illustrative example, the feature extraction engine 118 can apply one or more low pass filters to the orientation maps, and can use energy, difference, and/or contrast between orientation maps to obtain a local patch. A local patch can be a pixel level element. For example, an output of the orientation map processing can include a texture template or local feature map of the local patch of the face being processed. The resulting local feature maps can be concatenated to form a feature vector for the face image. Further details of using steerable filters for feature extraction are described in William T. Freeman and Edward H. Adelson, “The design and use of steerable filters,” IEEE Transactions on Pattern Analysis and Machine Intelligence, 13(9):891-906, 1991, and in Mathews Jacob and Michael Unser, “Design of Steerable Filters for Feature Detection Using Canny-Like Criteria,” IEEE Transactions on Pattern Analysis and Machine Intelligence, 26(8):1007-1019, 2004, which are hereby incorporated by reference, in their entirety and for all purposes.

Postprocessing on the feature maps such as LDA/PCA can also be used to reduce the dimensionality of the feature size. In order to compensate the errors in landmark detection, a multiple scale feature extraction can be used to make the features more robust for matching and/or classification.

The identification engine 119 performs object identification and/or object verification. Face identification and verification is one example of object identification and verification. For example, face identification (or face recognition) is the process to identify which person identifier a detected and/or tracked face should be associated with, and face verification (or face authentication) is the process to verify if the face belongs to the person to which the face is claimed to belong. The same idea also applies to objects in general, where object identification identifies which object identifier a detected and/or tracked object should be associated with, and object verification verifies if the detected/tracked object actually belongs to the object with which the object identifier is assigned.

Objects can be enrolled or registered in an enrolled database 108 that contains known objects. For example, an entity (e.g., a private company, a law enforcement agency, a governmental agency, or other entity) can register identifying information of known people into the enrolled database 108. In another example, an owner of a camera containing the object recognition system 100 can register the owner's face and faces of other trusted users. The enrolled database 108 can be located in the same device as the object recognition system 100, or can be located remotely (e.g., at a remote server that is in communication with the system 100). While the enrolled database 108 is shown as being part of the same device as the objection recognition system 100, the enrolled database 108 can be located remotely (e.g., at a remote server that is in communication with the objection recognition system 100) in some cases.

In some cases, the enrolled database 108 can include various templates that represent different objects. For instance, an object representation (e.g., a face representation) can be stored as a template in the enrolled database 108. Each object representation can include a feature vector describing the features of the object. The templates in the enrolled database 108 can be used as reference points for performing object identification and/or object verification. In one illustrative example, object identification and/or verification can be used to recognize a person from a crowd of people in a scene monitored by the camera. For example, a similarity can be computed between the feature representation of the person and a feature representation (stored as a template in the template database 108) of a face of a known person. The computed similarity can be used as a similarity score that will be used to make a recognition determination. For example, the similarity score can be compared to a threshold. If the similarity score is greater than the threshold, the face of the person in the crowd is recognized as the known person associated with the stored template. If the similarity score is not greater than the threshold, the face is not recognized as the known person associated with the stored template.

Object identification and object verification present two related problems and have subtle differences. Object identification can be defined as a one-to-multiple problem in some cases. For example, face identification (as an example of object identification) can be used to find a person from multiple persons. Face identification has many applications, such as for performing a criminal search. Object verification can be defined as a one-to-one problem. For example, face verification (as an example of object verification) can be used to check if a person is who they claim to be (e.g., to check if the person claimed is the person in an enrolled database). Face verification has many applications, such as for performing access control to a device, system, or other accessible item.

Using face identification as an illustrative example of object identification, an enrolled database containing the features of enrolled faces (e.g., stored as templates) can be used for comparison with the features of one or more given query face images (e.g., from input images or frames). The enrolled faces can include faces registered with the system and stored in the enrolled database, which contains known faces. A most similar enrolled face can be determined to be a match with a query face image. The person identifier of the matched enrolled face (the most similar face) is identified as the person to be recognized. In some implementations, similarity between features of an enrolled face and features of a query face can be measured with distance. Any suitable distance can be used, including Cosine distance, Euclidean distance, Manhattan distance, Mahalanobis distance, absolute difference, Hadamard product, polynomial maps, element-wise multiplication, and/or other suitable distance. One method to measure similarity is to use similarity scores, as noted above. A similarity score represents the similarity between features, where a very high score between two feature vectors indicates that the two feature vectors are very similar. A feature vector for a face can be generated using feature extraction, as described above. In one illustrative example, a similarity between two faces (represented by a face patch) can be computed as the sum of similarities of the two face patches. The sum of similarities can be based on a Sum of Absolute Differences (SAD) between the probe patch feature (in an input image) and the gallery patch feature (stored in the database). In some cases, the distance is normalized to 0 and 1. As one example, the similarity score can be defined as 1000*(1−distance).

Another illustrative method for face identification includes applying classification methods, such as a support vector machine to train a classifier that can classify different faces using given enrolled face images and other training face images. For example, the query face features can be fed into the classifier and the output of the classifier will be the person identifier of the face.

For face verification, a provided face image will be compared with the enrolled faces. This can be done with simple metric distance comparison or classifier trained with enrolled faces of the person. In general, face verification needs higher recognition accuracy since it is often related to access control. A false positive is not expected in this case. For face verification, a purpose is to recognize who the person is with high accuracy but with low rejection rate. Rejection rate is the percentage of faces that are not recognized due to the similarity score or classification result being below the threshold for recognition.

Object recognition systems can also perform object recognition using data obtained using infrared (IR) signals and sensors. For example, a camera (e.g., an internet protocol (IP) camera or other suitable camera) that has the ability to use IR signals for object recognition (e.g., face recognition) can emit IR signals in order to detect and/or recognize objects in a field of view (FOV) of the camera. In one illustrative example, IR emitters can be placed around the circumference of the camera to span across the FOV of the camera. The IR emitters can transmit IR signals that become incident on objects. The incident IR signals reflect off of the objects, and IR sensors on the camera can receive the return IR signals.

The return IR signals can be measured for time of flight and phase change (or structured light modifications), and an IR image can be created. For example, an IR camera can detect infrared energy (or heat) and can convert infrared energy into an electronic signal, which is then processed to produce a thermal image (e.g., on a video monitor). Alternatively, the IR signals can be modulated with a continuous wave (e.g., at 85 Megahertz (MHz) or other suitable frequency). The IR signal is reflected off of the object (e.g., a face), resulting in a return IR signal. This return IR signal has a different phase of the continuous wave. This is spanned across the FOV or scene (or face), and the individual return signal and its characteristics are composited into a composite image (or observed image). After the return IR signals are measured for the time of flight and phase change (or structured light modifications) and the IR image (e.g., the thermal IR image or the composite IR image) is created, objection recognition can be performed in the same way as object recognition for visible light images. For example, object detection and feature extraction can be performed using the thermal IR image or the composite IR image.

In some cases, the camera can perform detection prior to performing recognition. For instance, using face recognition as an example, the camera can project IR rays across a particular region, and can perform object detection to detect one or more faces. Once the camera detects a face as a result of performing the object detection, the camera can project a more directional IR signal toward the face in order to collect data that can be used for feature extraction and for performing object recognition. For instance, the camera can use the IR signals to generate a depth map that can be used to extract features for the face (or other object). In one illustrative example, an IR camera can be a time-of-flight IR camera that can determine, based on the speed of light being a constant, the distance between the camera and an object for each point of the image. The distance can be determined by measuring the round trip time of a light signal emitted from the camera. The camera can use the depth map information in an attempt to perform face recognition based on characteristics of the received IR signals.

Object recognition systems provide many advantages, such as providing security for indoor and outdoor environments having surveillance systems, identifying a person of interest (e.g., a criminal) among a crowd of people, among others. However, such systems also can introduce privacy concerns for people in a public or private setting.

Systems and methods are described herein that provide privacy augmentation using counter recognition techniques. For instance, one or more counter recognition techniques can be performed to provide a user with privacy from cameras that perform face recognition. As noted above, a camera that is configured to perform face recognition can include components such as imaging optics, one or more transmitters, one or more receivers, one or more processors that can implement the face recognition, among other components. One or more incident signals can be received, which can trigger the one or more counter recognition techniques. For instance, a counter recognition technique can be performed in response to receiving and/or detecting the one or more incident signals. Characteristics of an incident signal can be used to determine when and/or what type of counter recognition technique to perform. For example, depending on the type of incident signal, a counter recognition technique can be performed in order to prevent face recognition from being successfully performed. In some cases, multiple counter recognition techniques can be available for use by a device, and the device can choose which counter recognition technique(s) to apply based on the characteristics. The device can include a wearable device or other user device, such as a mobile device, mobile phone, tablet, or other user device.

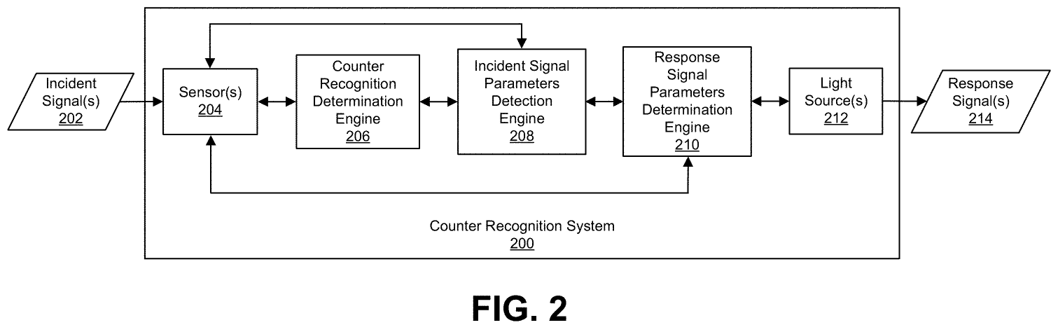

FIG. 2 is a diagram illustrating an example of a counter recognition system 200 for performing the counter recognition techniques described herein. The counter recognition system 200 can be included in a computing device. In some examples, the counter recognition system 200 can be part of a device. The device can be equipped with the signal processing and power capabilities to perform the counter recognition techniques described herein. The device including the counter recognition system 200 can include any suitable device. For instance, the device can include a wearable device in some implementations. For example, the wearable device can include glasses worn on a user's face, a hat, a necklace, or other suitable wearable device. In some examples, the counter recognition can be implemented using a user device other than a wearable device, such as a mobile device, mobile phone, tablet, or other user device. For example, a user viewing their mobile phone can be walking in an environment with one or more surveillance cameras that can perform face recognition (or other object recognition). The mobile phone can detect an incident signal (e.g., an IR signal), and can begin performing one or more of the counter recognition techniques described herein.

While examples are described herein using a wearable device (and in particular glasses) as an illustrative example of the device, one of skill will appreciate that any suitable device that can be equipped with the sensors and other components described below can be used to implement the counter recognition techniques to provide privacy from cameras that perform object (e.g., face) recognition. Furthermore, while examples are provided using face recognition as an example of object recognition, one of ordinary skill will appreciate that the techniques described herein can be performed to prevent detection and/or recognition of any type of object.

The counter recognition system 200 has various components, including one or more sensors 204, a counter recognition determination engine 206, an incident signal parameters detection engine 208, a response signal parameters determination engine 210, and one or more light sources 212. The components of the counter recognition system 200 can include and/or can be implemented using electronic circuits or other electronic hardware, which can include one or more programmable electronic circuits (e.g., microprocessors, graphics processing units (GPUs), digital signal processors (DSPs), central processing units (CPUs), and/or other suitable electronic circuits), and/or can include and/or be implemented using computer software, firmware, or any combination thereof, to perform the various operations described herein. While the counter recognition system 200 is shown to include certain components, one of ordinary skill will appreciate that the counter recognition system 200 can include more or fewer components than those shown in FIG. 2. For example, the counter recognition system 200 may also include, in some instances, one or more memory devices (e.g., one or more random access memory (RAM) components, read-only memory (ROM) components, cache memory components, buffer components, database components, and/or other memory devices), one or more processing devices (e.g., one or more CPUs, GPUs, and/or other processing devices), one or more wireless interfaces (e.g., including one or more transceivers and a baseband processor for each wireless interface) for performing wireless communications, one or more wired interfaces (e.g., universal serial bus (USB), a lightening connector, and/or other wired interface) for performing communications over one or more hardwired connections, and/or other components that are not shown in FIG. 2.

The one or more sensors 204 can include any type of sensor that can receive one or more incident signals 202. For example, the one or more sensors 204 can include an infrared (IR) sensor (also referred to as an IR camera), a near-infrared (NIR) sensor (also referred to as an NIR camera), and/or an image sensor (e.g., a camera) that can capture images using visible light (e.g., still images, videos, or the like). An IR sensor can capture IR signals, which are signals with wavelengths and frequencies that fall in the IR electromagnetic spectrum. The IR electromagnetic spectrum includes wavelengths in the range of 2,500 nanometers (nm) to 1 millimeter (mm), corresponding to frequencies ranging from 430 terahertz (THz) to 300 gigahertz (GHz). The infrared spectrum includes the NIR spectrum, which includes wavelengths in the range of 780 nm to 2,500 nm. In some cases, the counter recognition system 200 can include an IR sensor configured to capture IR and NIR signals. In some cases, separate IR and NIR sensors can be included in the counter recognition system 200.

An image sensor can capture color images generated using visible light signals. The color images can include: red-green-blue (RGB) images; luma, chroma-blue, chroma-red (YCbCr or Y′CbCr) images; and/or any other suitable type of image. In one illustrative example, the counter recognition system 200 can include an RGB camera or multiple RGB cameras. In some cases, the counter recognition system 200 can include an IR sensor and an image sensor due to the ability of cameras to perform face recognition using either IR data or visible light data. Having both an IR sensor and image sensor provides the counter recognition system 200 with the ability to detect and counter both types of face recognition. In some examples, separate IR and near-infrared (NIR) sensors can be included in the counter recognition system 200.

The one or more light sources 212 can include any type of light sources that can emit light. For example, the one or more light sources 212 can include an IR light source, such as an IR flood illuminator, an IR pulse generator, and/or other type of IR light source. In another example, the one or more light sources 212 can include a structured light projector that can project visible light, IR signals, and/or other signals in a particular pattern. In some examples, the counter recognition system 200 can include an IR light source and a structured light (SL) projector. In one example implementation, IR illuminators can be added along the rim of the wearable device. In another example implementation, the SL projector can include an IR structured light module (e.g., using IR and/or NIR energy) with a dot pattern illuminator, which can be embedded in the wearable device.

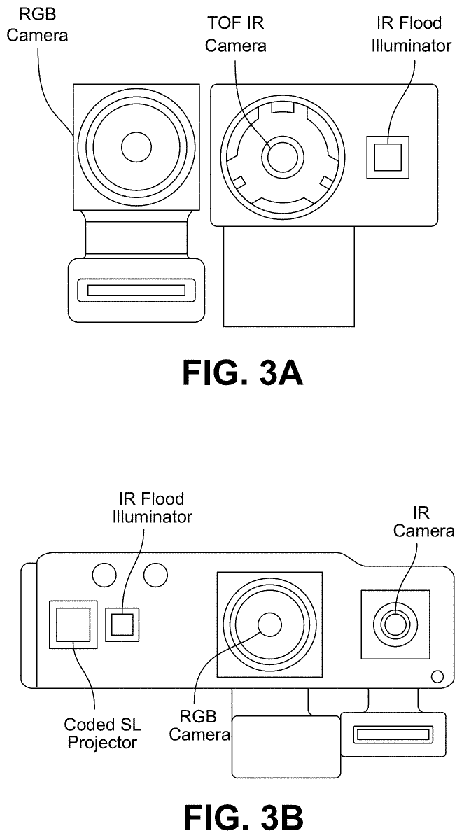

FIG. 3A and FIG. 3B are diagrams illustrating examples of different configurations of image sensors and light sources that can be included in the counter recognition system 200. As shown in FIG. 3A, the counter recognition system 200 can include an RGB camera, a time-of-flight (TOF) IR camera, and an IR flood illuminator. A TOF IR camera is a range imaging camera system that can perform time-of-flight techniques based on the speed of light being known constant. The TOF IR camera can determine the distance between the camera and an object (e.g., a person's face) for each point of the image, by measuring the round trip time of a light signal emitted by the counter recognition system 200 (e.g., an IR signal provided by an IR light source). In some implementations, a standard IR camera that transforms received IR energy into thermal image can be used instead of or in addition to the TOF IR camera. The IR flood illuminator can generate IR light signals. For example, the IR flood illuminator can be a continuous IR illuminator with a single intensity. In some examples, the IR flood illuminator can be a pulsed IR flood illuminator. A pulsed IR flood illuminator has segments that can be individually excited to create pulses of IR signals. The pulses of IR signals can be configured in the form of a spatial pattern and/or in the time domain (e.g., repetitive pulses). Given a known incident pattern and the pattern from the return signal, an image of the object being scanned by the IR signals can be generated.

FIG. 3B illustrates another configuration of image sensors and light sources for the counter recognition system 200. As shown, the counter recognition system 200 can include an RGB camera, an IR camera, an IR flood illuminator, and a coded structured light (SL) projector. In some examples, the IR camera can be a standard IR camera that transforms received IR energy into thermal image. In some examples, the IR camera can be a TOF IR camera. A SL projector can project a configurable pattern of light. The SL projector can include a transmitter and a receiver. The transmitter can project or transmit a distribution of light points onto a target object. For example, one or more patterns of light can be projected to target certain portions of a user's face, as described in more detail below. While some examples describe the projected light as including a plurality of light points or other shapes, the light may be focused into any suitable size and dimensions. For example, the light may be projected in lines, squares, or any other suitable dimension. In some cases, a SL projector can act as a depth sensing system that can be used to generate a depth map of a scene.

In some example implementations, the light projected by the transmitter of an SL projector can be IR light. As noted above, IR light may include portions of the visible light spectrum (e.g., NIR light) and/or portions of the light spectrum that are not visible to the human eye (e.g., IR light outside of the NIR spectrum). For instance, IR light may include NIR light, which may or may not include light within the visible light spectrum. In some cases, other suitable wavelengths of light may be transmitted by the SL projector. For example, light can be transmitted by the SL projector in the ultraviolet light spectrum, the microwave spectrum, radio frequency spectrum, visible light spectrum, and/or other suitable light signals.

As noted above, some cameras can perform face recognition using IR signals. For example, IR emitters of an IP camera can transmit IR signals that become incident on the wearable device that includes the counter recognition system 200, and on the face of the user of the wearable device. The incident IR signals reflect off of the face and the wearable device, and IR sensors on the IP camera can receive the return IR signals. The camera can use the IR signals in an attempt to perform face recognition based on characteristics of the received IR signals. The counter recognition system 200 can perform a counter recognition technique to prevent IR-based object recognition.

Some cameras can also perform face recognition using color images generated using visible light signals. For example, as described above with respect to FIG. 1, image processing can be performed to extract facial features from the images, and the facial features can be compared to stored facial features (e.g., stored in an enrolled database as templates) of faces of known people. The counter recognition system 200 can also perform a counter recognition technique to prevent color image-based object recognition.

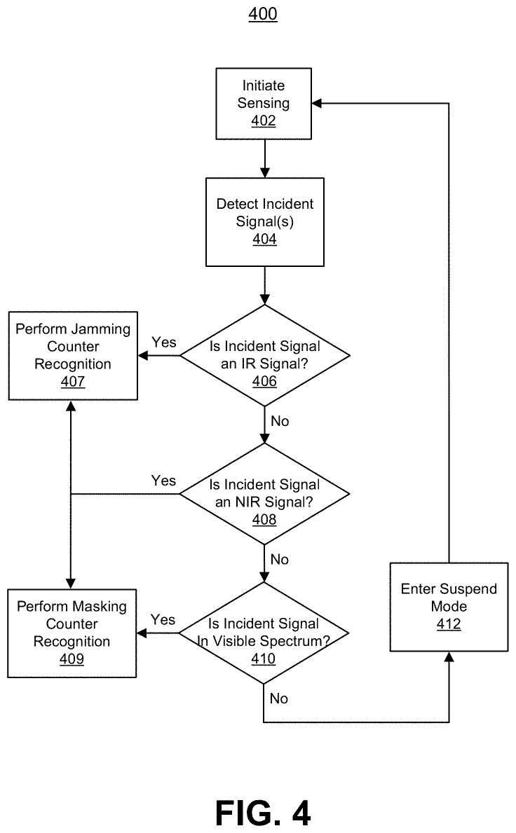

The counter recognition determination engine 206 can receive and/or detect signals that are incident on the wearable device (referred to as “incident signals”), and can determine a type of counter recognition technique to perform based on characteristics of the incident signals. FIG. 4 is a flowchart illustrating an example of a process 400 of selecting a counter recognition technique. The process 400 can be performed by the counter recognition system 200.

At block 402, the process 400 includes initiating sensing of any possible incident signals. In some cases, the counter recognition system 200 can leverage information from sensing performed by other devices, such as one or more other wearable devices (e.g., a smartwatch) or Internet-of-Things (IoT) devices. One or more triggers for initiating sensing can be manual and/or automatic. For instance, an automatic trigger can be based on sensed signals or based on other extraneous factors in the environment deduced through other sensors (e.g. motion detection, location, a combination of detection and location, among others). In some examples, sensing can be initiated based on a user selecting an option to turn on the incident signal detection. For instance, a user may press or toggle a physical button or switch to initiated sensing. In another example, a user may select or gaze at a virtual button displayed using augmented reality (AR) glasses. In another example, a user may issue a voice command to initiate sensing or to begin counter recognition, which can cause the sensing of incident signals to be initiated. Any other suitable input mechanism can also be used. In some examples, the sensing of incident signals may be automatically initiated. In one example, the duration and frequency for sensing and performing one or more of the counter recognition techniques can be determined based on periodicity and patterns observed from one or more cameras with object recognition capabilities. In another example, the counter recognition system 200 may automatically begin sensing incident signals based on a location of the wearable device. For instance, a position determination unit (e.g., a global positioning system (GPS) unit, a WiFi based positioning system that can determine location based on signals from one or more WiFi access points, a position system that determines location based on radio frequency (RF) signature, or the like) on the wearable device can determine a location of the wearable device.

At block 404, the process 400 includes receiving and/or detecting one or more incident signals. An incident signal can be received and/or detected by the one or more sensors 204 of the counter recognition system 200. For example, an IR sensor can detect IR signals and/or NIR signals. In some cases, an NIR sensor (if included in the system 200) can detect NIR signals. For example, an IR sensor of the counter recognition system 200 (as an example of a sensor 204) can receive and process the incident IR signals. In some cases, the IR sensor can process an IR signal by demodulating the IR signal and outputting a binary waveform that can be read by a microcontroller or other processing device. A camera (e.g., an RGB camera), an optical or light sensor, and/or other suitable device of the counter recognition system 200 can receive visible light signals (e.g., image signals, light signals, or the like) in the visible spectrum. In some examples, receiving an incident signal at block 404 can include receiving an image signal of a camera (e.g., an RGB image signal, or other type of image signal).

The counter recognition determination engine 206 can determine a type of counter recognition technique to perform based on certain characteristics associated with the incident signals. For example, based on the type of incident signal, the process 400 can determine which counter recognition technique to perform. Examples of types of incident signals include IR signals, NIR signals, and signals that are in the visible light spectrum. At block 406, the process 400 can determine whether an incident signal is an IR signal. If an incident signal is detected as an IR signal (a “yes” decision at block 406), the process 400 can perform a jamming counter recognition technique at block 407. The jamming counter recognition technique is described in more detail below.

If, at block 406, the process 400 determines that the incident signal is not an IR signal, the process 400 can proceed to block 408 to determine whether the incident signal is an NIR signal. If the incident signal is determined to be an NIR signal at block 408, the process 400 can perform the jamming counter recognition technique at block 407, the masking counter recognition technique at block 409, or both the jamming counter recognition technique and the masking counter recognition technique. The masking counter recognition technique is described in more detail below. In some cases, the counter recognition system 200 can determine whether to perform the jamming counter recognition technique and/or the masking counter recognition technique when there is an NIR signal. For example, when it is desired that the masking measures are performed in a non-obvious manner (e.g., are non-detectable by the camera), only the jamming counter recognition technique may be applied if the camera performing object recognition is in close proximity to the counter recognition system 200.

If the process 400 determines at block 408 that the incident signal is not an NIR signal, the process 400 can continue to block 410 to determine whether the incident signal is a visible light spectrum signal (referred to as a “visible light signal”) and/or whether the visible light incident signal has one or more characteristics. For example, in some cases, the one or more characteristics of a visible light signal can be analyzed to determine whether to perform the masking counter recognition. As used herein, light in the visible light spectrum can include all visible light that can be sensed by a visible light camera, such as an RGB camera or other camera, an optical sensor, or other type of sensor. If the incident signal is determined to be a visible light signal, and/or is determined to have the one or more characteristics, at block 410, the process 400 can perform the masking counter recognition technique at block 409.

As noted above, in some cases, block 404 can include receiving an image signal (e.g., an RGB image signal, or other type of image signal). For example, the device can capture an image of a scene or environment in which the device is located. In some implementations, the jamming and/or masking counter recognition technique can be triggered and performed in response to detecting a camera in a captured image. For example, the device can be trained to perform a counter recognition technique upon detection of a camera (e.g., a security camera) form factor in an image. In one illustrative example, using standard computer vision, object detection, machine learning based object detection (e.g., using a neural network), or other suitable techniques, the device can process a frame to detect whether a camera is present in the image, and a counter recognition technique can be performed if a camera is detected.

The one or more characteristics of an incident signal in the visible light spectrum can include any characteristic of the visible light signal, such as illumination (e.g., based on luminance) or brightness, color, temperature, any suitable combination thereof, and/or other characteristic. In one illustrative example, an RGB camera and ambient light sensor on the wearable device can detect and/or measure available illumination and assess how well a camera will be able to conduct object recognition (e.g., face recognition). For instance, if the brightness of the light is low, the process 400 may determine not to perform the masking counter recognition due to the low likelihood that there are cameras that can perform object recognition in a dark setting. In another example, an RGB camera on a wearable device can detect shadows more accurately than a camera (e.g., an IP camera) performing object recognition, in which case the masking counter recognition can be performed. In some examples, the masking counter recognition technique can be performed depending on location or persona, with or without taking into account whether an incident signal has certain characteristics. In one illustrative example, if a user of the wearable device is in a location with diffused light of varying intensities (e.g., a mall with sky lights, outdoors where light is not broad daylight but diffused light of varying intensities, etc.), the masking counter recognition technique can be performed. The masking counter recognition technique can be successful in such conditions because the masking will blend with the light features.

If the process 400 determines that the incident signal is not a visible light signal, the process 400 will cause the counter recognition system 200 to enter a suspend mode at block 412. In some implementations, in the suspend mode, the counter recognition system 200 may not detect incident signals as they become incident on the one or more sensors 204. In some implementations, in the suspend mode, the counter recognition system 200 may apply one or more of the counter recognition techniques at a lower rate or duty cycle than when the counter recognition system 200 is not in the suspend mode. The suspend mode can allow the wearable device to conserve power.

The decision of whether to go to suspend mode can be based on hysteresis and/or a history. For example, a history can be maintained of when the counter recognition techniques are performed. In some cases, using the history, if the wearable observes a pattern of incident light characteristics that was observed before (e.g., based on machine learning, such as using a neural network or other machine learning tool), the counter recognition system 200 may apply similar counter recognition techniques as before, or apply modified counter recognition techniques in order to randomize its own observed behavior. Hysteresis is the dependence of the state of a system on its history. Hysteresis of a counter signal has a lifetime during which the counter recognition system 200 can go into suspend mode until it is time to turn on sensing based on an observed incident signal meeting the criteria noted above (e.g., an IR signal is detected at block 406, an NIR signal is detected at block 408, an incident signal in the visible light spectrum having the one or more characteristics is detected at block 410, etc.). In some cases, the counter recognition system 200 can go into suspend mode until an observed pattern or oscillation in an incident signal is detected, which can allow the system 200 to avoid continuous sensing to save power.

In some examples, in response to detecting a signal incident on the wearable device, the wearable device can provide metadata associated with the incident signals. For example, the metadata can include signal parameters, such as amplitude, frequency, center frequency, phase, patterns of signals, oscillations of signals, and/or other parameters. The metadata can be used when performing the different counter recognition techniques.

A sensor of the counter recognition system 200 that detects incident signals can provide the incident signals to the incident signal parameters detection engine 208. The incident signal parameters detection engine 208 can determine signal parameters of the incident signals. The signal parameters for an incident signal can include characteristics of the frequency signal (e.g., amplitude, frequency, center frequency, phase, and/or other characteristics) and/or can include characteristics of the incident light provided by the incident signal (e.g., contrast, color temperature, brightness, a number of lumens, light pattern, and/or other light characteristics). The signal parameters that are determined by the signal parameters detection engine 208 can be based on the type of counter recognition technique that is to be performed (as determined by the counter recognition determination engine 206).

The signal parameters of the incident signals can be used to perform the one or more counter recognition techniques. For example, the incident signal parameters detection engine 208 can send the incident signal parameters to the response signal parameters determination engine 210. The response signal parameters determination engine 210 can then determine parameters of a response signal based on the signal parameters of an incident signal. Response signals 214 having the response signal parameters can be emitted by the one or more light sources 212 in order to counteract face recognition by a camera. Similar to the signal parameters that are determined by the signal parameters detection engine 208, the response signal parameters determined by the response signal parameters determination engine 210 can be based on the type of counter recognition technique that is to be performed.

In some implementations, the jamming counter recognition technique noted above can be used to prevent face recognition from being performed by a camera of a surveillance system. The jamming counter recognition technique can use signals (e.g., IR signals, NIR signals, and/or other suitable signals) to effectively jam incident signals (e.g., IR signals, NIR signals, and/or other suitable signals) emitted from a camera, which can prevent the camera from performing face recognition (or other type of object recognition). In one illustrative example, using the jamming counter recognition technique, an IR light source (e.g., an IR illuminator) of the counter recognition system 200 can project IR signals toward the surveillance camera in order to jam the incident signals from the surveillance camera. The response signal parameters of the projected IR signals can be determined by the response signal parameters determination engine 210 based on the incident signal parameters determined by the incident signal parameters detection engine 208.

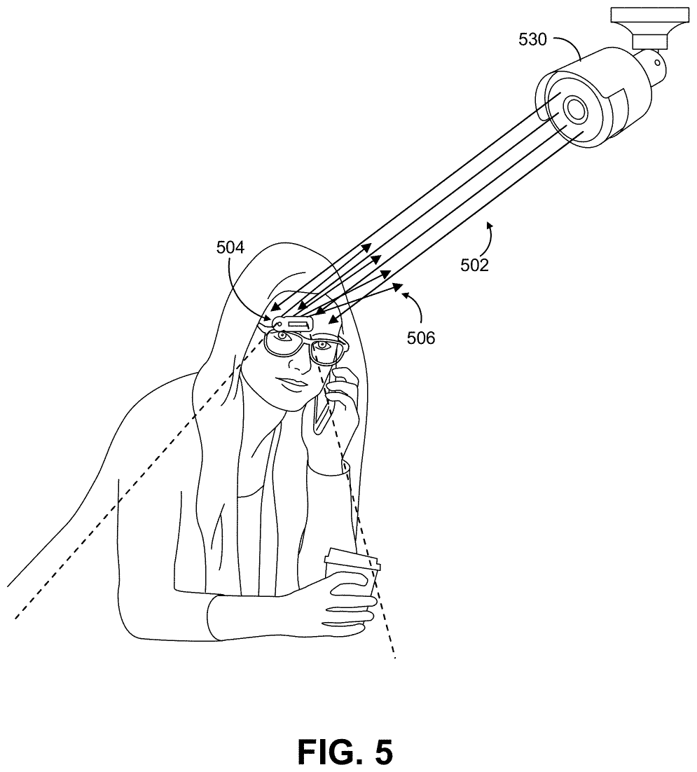

FIG. 5 is a diagram illustrating an example of the jamming counter recognition technique. Examples of the jamming counter recognition technique will be described using IR signals as incident and responses signals. While IR signals are used as an illustrative example, one of ordinary skill will appreciate that the jamming counter recognition technique can be performed using other types of signals (e.g., NIR signals, UV signals, among others). The jamming counter recognition technique can combine detection of an IR signal reciprocated with an IR response signal (acting as an interference signal) in the opposite direction, which can disrupts object recognition.

As shown in FIG. 5, an IR camera 504 (as an example of the one or more sensors 204) of the counter recognition system 200 can detect incident IR signals 502 from the camera 530 performing object recognition. The signal parameters detection engine 208 can calculate signal parameters of the incident IR signals 502. The signal parameters calculated for the jamming counter recognition technique can include amplitude, frequency, and phase of an incident IR signal. The frequency of a signal (which is effectively a wave) is the number of times the repeating waveform of the signal occurs each second, as measured in Hertz (Hz). The amplitude is the height of the signal's waveform, from the center line to the peak or trough. The phase of any point (e.g., point in time) on a waveform is the relative value of that point within a full period of the waveform signal (e.g., the offset of the point from the beginning of the period). In some cases, the signal parameters can also include a center frequency. In some cases, the signal parameters detection engine 208 can extract amplitude, phase, modulation, and the energy spread across the frequency spectrum.

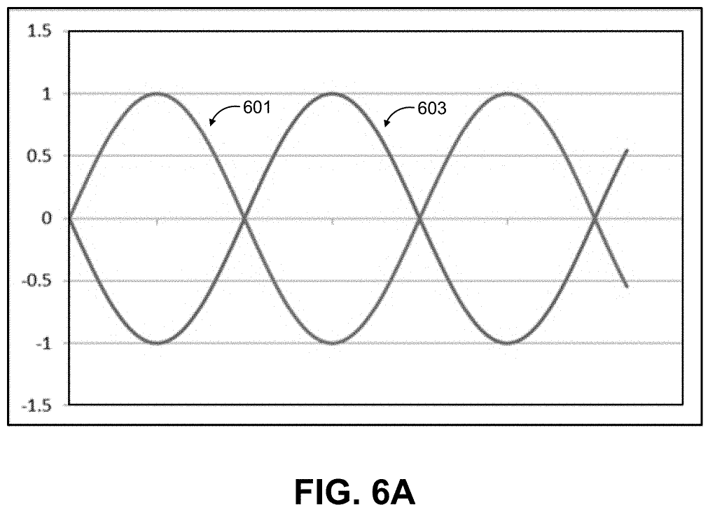

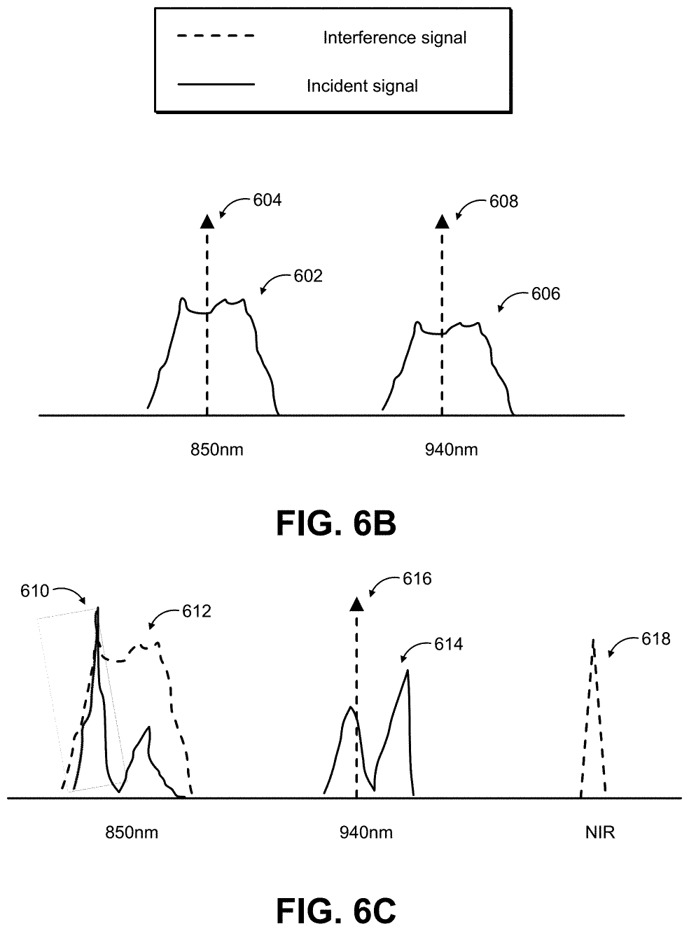

The signal parameters detection engine 208 can provide the signal parameters to the response signal parameters determination engine 210. The response signal parameters determination engine 210 can determine response signal parameters of a response signal by estimating the inverse of the signal parameters of the incident signal. In some examples, the inverse signal parameters of a response signal can include the same amplitude and frequency as that of the incident IR signal, and an inverse of the phase of the incident IR signal. FIG. 6A is a diagram illustrating an example of an incident signal 601 and a response signal 603 having a phase that is the inverse of the phase of the incident signal. For example, the response signal 603 is 180 degrees out of phase (e.g., has a 180 degree phase shift) as compared to the incident signal 601 (hence the inverse phase) due to the incident signal 601 being at its highest peak while the response signal 603 is at its lowest peak. The incident signal 601 and the response signal 603 cancel each other out due to interference between the waves of two signals 601 and 603, which is based on the inverse phase and the two waves having the same amplitude in opposite directions. For example, two identical waves that are 180 degrees out of phase will cancel each other out in a process called phase cancellation or destructive interference. In some implementations, the amplitudes of the incident signal 601 and the response signal 603 do not have to match exactly in order to sufficiently distort the object recognition being performed by the camera. For instance, the amplitude of the response signal 603 can be between 1 and 0.2 times the amplitude of the incident signal 601, while still sufficiently distorting the object recognition. In some cases, the incident signal 601 and the response signal 603 can have various duty cycles and intensities.

In some cases, the response signal can be at a frequency that jams the entire frequency spectrum of the incident signal. In some cases, the response signal does not need to jam the entire spectrum, depending on the amplitude. For instance, the response signal can be a pulse (e.g., the dotted lines in FIG. 6B and FIG. 6C, described below) or can have a small frequency range. A response pulse with a suitable amplitude can desensitize the camera's receiver (e.g., by saturating the sensitivity of the camera's sensor). For instance, a response pulse signal having the same amplitude, the same center frequency, and an inverse of the phase of the incident signal can desensitize the camera's receiver.

An IR light source (e.g., an IR illuminator, an IR flood illuminator, a pulsed IR flood illuminator, or the like), or other suitable light source 212, of the counter recognition system 200 can emit response IR signals 506 (having the inverse signal parameters) back towards the camera 530, jamming the incident signal with the inverse signal. The response IR signals 506 (also referred to as an interference signals) effectively reduce signal-to-noise ratio (SNR) in the camera 530 performing object recognition. A response signal can be a broad spectrum jamming signal (e.g., response signal 612 in FIG. 6C) or can be a control signal (e.g., a pulse signal, such as response signal 616 in FIG. 6C). In one illustrative example, a control signal can be a single frequency pulse with a duty cycle of 0.2% at the amplitude of the detected IR. The effect on a camera due to IR jamming is cancellation of the incident IR signals, which disrupts object recognition. NIR counter measures are similar to IR jamming technique described above, except the response signal is shifted to NIR center frequency, which enables least probability of detection.

The cancellation of the IR signals may be observed by a camera as dark spots along the glasses (e.g., as dark spots in images generated by the camera). The dark spots are the source of the inverse IR signals. The dark spots can be made undetectable or difficult to detect. For example, one or more IR light sources that emit the inverse IR signals can be placed around the rim of wearable glasses, in which case the dark spots will blend with the rim of the glasses. The dark spots become lighter and blurrier with increased range from the camera.

FIG. 6B and FIG. 6C are diagrams illustrating examples of incident signals and corresponding interference signals. As shown in FIG. 6B, the incident signal 602 is an IR signal that has a wavelength of 850 nanometers (nm), and the corresponding response signal 604 (as an interference signal) is an IR pulse signal with a wavelength of 850 nm. The amplitude of the response signal 604 is the same as the amplitude of the incident signal 602, while the phase of the response signal 604 is the inverse of the phase of the incident signal 602. The incident signal 606 is an IR signal that has a wavelength of 940 nm. The corresponding response signal 608 is an IR pulse with a wavelength of 940 nm and with the same amplitude as that of the incident signal 606. The phase of the response signal 608 is the inverse of the phase of the incident signal 606.

In FIG. 6C, the incident signal 610 is an IR signal with a wavelength of 850 nanometers (nm), and the corresponding response signal 612 a broad spectrum IR signal at the 850 nm wavelength. The amplitude of the response signal 612 is within a certain threshold different from the amplitude of the incident signal 610, and the phase of the response signal 612 is the inverse of the phase of the incident signal 610. The threshold difference can be based on a percentage or fraction, such as 100% (in which case the amplitudes are the same), 90% (the amplitude of the response signal 612 is 90% of the amplitude of the incident signal), 50% (the amplitude of the response signal 612 is 50% of the amplitude of the incident signal), 20% (the amplitude of the response signal 612 is 20% of the amplitude of the incident signal), or other suitable amount. The threshold difference can be set so that the amplitude of the response signal 612 is close enough to the amplitude of the incident signal 610 to provide enough cancellation between the signals so that object recognition cannot be accurately performed. The incident signal 614 is an IR signal having a wavelength of 940 nm. The corresponding response signal 616 is an IR pulse with a wavelength of 940 nm and with the same amplitude as that of the incident signal 614. The phase of the response signal 616 is the inverse of the phase of the incident signal 614. The response signal 618 is an NIR signal. NIR signals can also disrupt cameras that perform object recognition using visible light images (e.g., RGB images). Using an NIR signal as a response signal can enable the least probability of detection because NIR signals are not detectable by RGB cameras.

As noted above, a camera performing object recognition will emit several IR signals towards the person (or other object) in order to obtain enough information to perform face recognition. There may be a delay period between when the IR signals become incident on the wearable device and when the inverse signals are emitted back towards the camera. However, the response signals having the inverse parameters can be emitted before the camera has enough time to obtain enough information to complete the face recognition. For instance, based on known time of flight systems, it may take four frames at 30 frames per second (fps) or 15 fps (corresponding to 132 ms or 264 ms, respectively) for the camera to collect enough information to perform facial recognition. The jamming counter recognition can be performed in enough time to counter the IR-based object recognition, prevents the facial recognition from being performed. For example, the IR-based jamming counter recognition can achieve a duty cycle of 20 milliseconds on-time (when the IR response signals are sent) for very one second of off-time. In some cases, during the delay period, a broad-based illumination of IR response signals across certain frequencies (850 and 940 nanometers) can be emitted, which may appear as a flash for a short period of time. The broad-based response signals can interrupt object recognition until the more discrete IR signals (having the inverse parameters) can be sent.

In some implementations, an adaptive masking technique can be used to prevent face recognition. To perform the adaptive masking technique, the one or more light sources 212 of the counter recognition system 200 can send response signals to targeted landmarks (e.g., face landmarks when countering face recognition) of a person that is wearing the wearable device. The landmarks that are targeted can be those that are used for face recognition by a camera performing object recognition. In one illustrative example, an IR flood illuminator or pulsed IR flood illuminator can project response signals (e.g., IR or NIR signals) onto the targeted landmarks. In another illustrative example, pattern modulation can be performed by the IR illuminator of the wearable device. For instance, a coded structured light projector can be configured to adaptively add a light pattern introducing noise to landmark regions of a user's face to prevent face recognition. The response signal parameters determination engine 210 can determine parameters of the response signals based on a particular landmark that is targeted, based on characteristics of the incident light, among other factors.

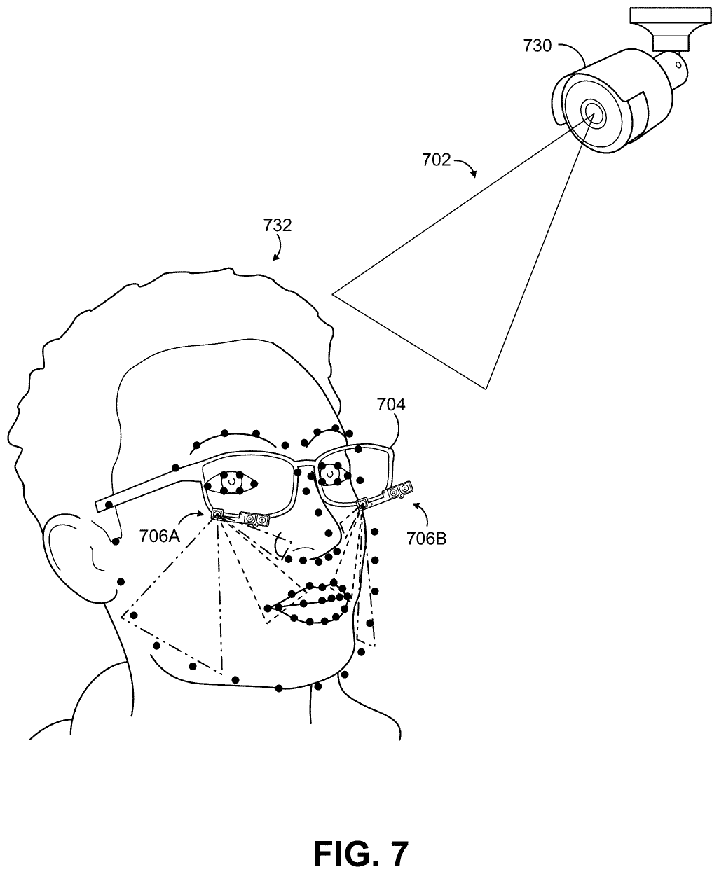

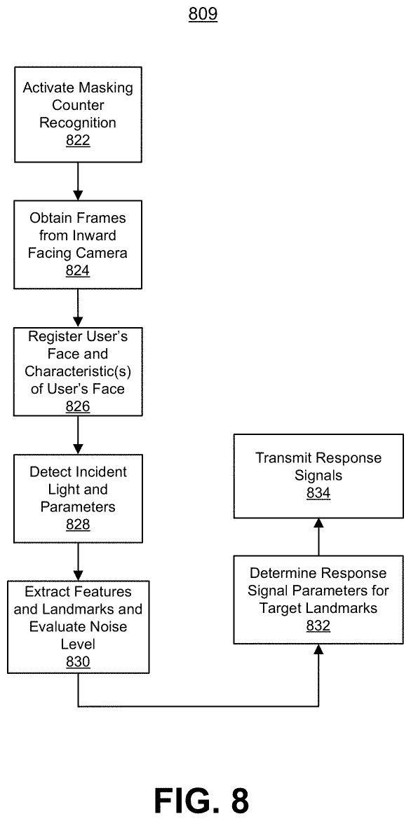

The masking counter recognition technique will be described with respect to FIG. 7 and FIG. 8. FIG. 7 is a diagram illustrating an example application of the masking counter recognition technique, and FIG. 8 is a flowchart illustrating an example of a process 809 for performing the masking counter recognition technique. Examples of the masking counter recognition technique will be described using visible light signals as responses signals. While visible light signals are used as an illustrative example, one of ordinary skill will appreciate that the masking counter recognition technique can be performed using other types of signals (e.g., IR signals, NIR signals, UV signals, among others). Further, while examples of the masking counter recognition technique will be described with respect masking a user's face from being recognized using face recognition, one of ordinary skill will appreciate that the masking counter recognition technique can be performed to mask any object.

At block 822, the process 809 includes activating masking counter recognition. For example, as described with respect to FIG. 4, the masking counter recognition technique can be activated in response to detecting that at least one incident signal 702 on the wearable device 704 is in the visible light spectrum.

At block 824, the process 809 includes obtaining frames from an inward facing camera. For example, a first image sensor (referred to as an “inward facing camera”) of the counter recognition system 200 can be directed toward the face of the user 732. The inward facing camera can be used to capture the frames (also referred to as images) of the user's face in order to register the face of the user (e.g., for determining face landmarks) and to register illumination information. The inward facing camera can include an RGB camera, or other suitable camera. As described in more detail below, the frames captured by the inward facing camera can be used to determine face landmarks of the user's face. The inward facing camera can be integrated with a first part 706A of the wearable device 704 or a second part 706B of the wearable device 704. In some cases, multiple inward facing cameras can be used to capture the frames.

The frames captured by the inward facing camera can be analyzed to determine characteristics of the face of the user 732. In one illustrative example, illumination of the user's face can be determined from the captured frames. For instance, the luma values of the pixels corresponding to the user's face can be determined (e.g., using contrast and G intensity in RGB). At block 826, the process 809 includes registering the face of the user 732 and the characteristics of the user's face. Registering the face of the user 732 can include locating the face in a frame.

At block 828, the process 809 includes detecting incident light on the wearable device 704 and detecting parameters of the incident light. For example, a second image sensor (referred to as an “outward facing camera”) of the counter recognition system 200 can be directed outward from the face of the user 732, and can be used to detect the incident visible light on the wearable device 704. The outward facing camera can be integrated with the first part 706A of the wearable device 704 or the second part 706B of the wearable device 704. In some cases, multiple outward facing cameras can be used to detect the incident visible light. The outward facing camera can include an RGB camera, or other suitable camera.

The inward facing camera and the outward facing camera can send the visible light signals to the incident signal parameters detection engine 208. The incident signal parameters detection engine 208 can determine signal parameters of the visible light signals. The signal parameters of the visible light signals can include one or more characteristics of the incident light, such as contrast, color temperature, brightness, a number of lumens, light pattern, any combination thereof, and/or other light characteristics. The signal parameters of the visible light can be used to determine parameters of response signals that will be projected onto the user's face. In one illustrative example, dot patterns projected by a coded structured light projector can be adapted to the lighting conditions (including any extraneous incident light in addition to ambient light).

At block 830, the process 809 includes extracting features and landmarks from the frames, and evaluate noise levels (e.g., signal-to-noise ratio (SNR)) of the features and landmarks (or for groups of features and/or for groups of landmarks). As noted above, the frames captured by the inward facing camera can be used to determine face landmarks of the user's face. The response signals can be projected onto certain target face landmarks on the face of the user 732 in order to mask the facial features of the user 732 from being recognized by the camera 730. The target face landmarks can include the features and landmarks that are most relied upon for face recognition by a camera. In one illustrative example, 12-32 face landmark points are accessible from the wearable device 704. Examples of primary facial features used for face recognition include Inter-eye distance (IED), eye to tip of mouth distance, amount of eye-openness, and various landmark points around the eyes, noise, mouth, and the frame of a face, among others. As illustrated by the points in FIG. 7, examples of landmark points include one or more points between a person's eyes, points along the edges of the eyes, points along the eyebrows, points on the bridge of the nose and under the nose, points associated with the mouth, and points along the chin line. Other examples of landmark points can be on the user's forehead, cheek, ears, among other portions of a person's face.

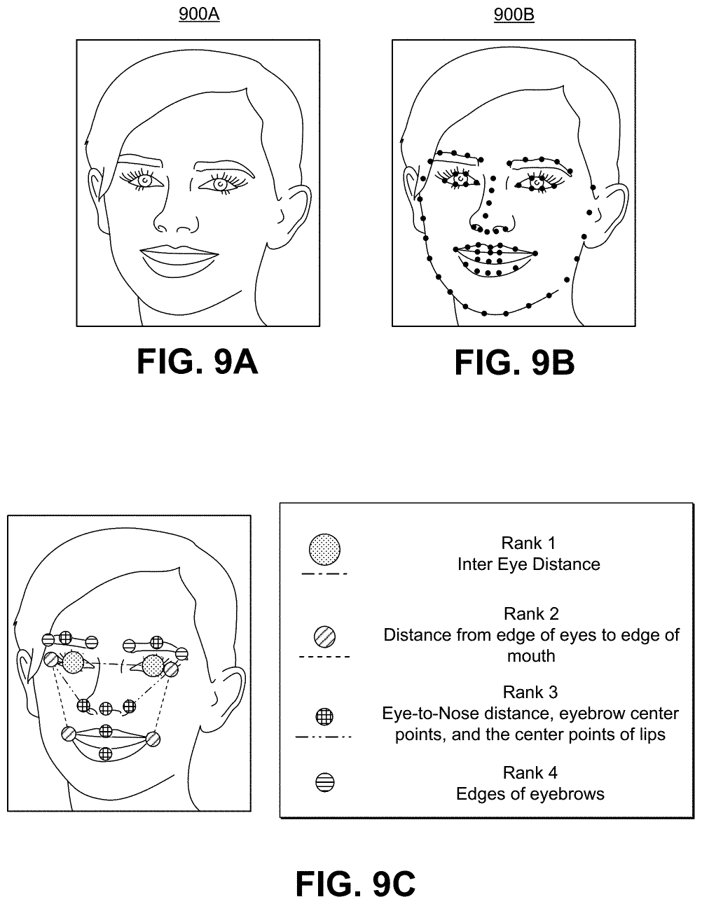

In some implementations, the face landmarks can be ranked in order to determine the target landmarks to which response signals will be directed. For example, sensitivities of the various landmarks can be ranked for target cameras, and can be weighted accordingly in the algorithms that are input to the light source (e.g., the coded structured light projector). For example, the landmarks can be ranked based on the extent to which the different landmark features are relied upon by facial recognition algorithms. The more important the face landmarks are to face recognition, the higher the ranking. FIG. 9A, FIG. 9B, and FIG. 9C illustrate an example of ranking face landmarks. The image 900A shown in FIG. 9A is an example of an image of a person captured by an RGB camera. The image 900B shown in FIG. 9B indicates typical landmarks extracted by face recognition algorithms.

Sensitivities of the landmarks (shown in FIG. 9B) to face recognition algorithms can be determined through characterization based on reliance by the face recognition algorithms of those landmarks in extracting descriptors of features to compare against templates. For example, tests can be run to evaluate the ability of various face recognition algorithms when landmarks are masked (e.g., physically on face using masks), and to identify the sensitivity of each landmark. The SNR required for faithful extraction of descriptors is analyzed and utilized in the masking counter recognition technique. For example, it can be determined how much noise in an image (e.g., an image signal) a face recognition algorithm can work with. The landmarks can be grouped and ranked based on the sensitivities of the landmarks, as shown in FIG. 9C. For example, it can be determined that a face recognition algorithm is most sensitive to inter-eye distance, and thus the inter-eye distance can be given the highest rank (Rank 1). The distance from the edge of the eyes to the edge of the mouth can be given a next highest rank (Rank 2). The distance from the edge of the eyes to the edge of the nose, center points of the eyebrows, and the center points of the top and bottom lips of the user can be grouped together, and can be given the third highest rank (Rank 3). The edges of the eyebrows can be assigned the lowest rank (Rank 4).

At block 832, the process 809 includes determining response signal parameters for the target landmarks. The response signal parameters can also be referred to as noise signal parameters, as the response signals act as noise signals from the perspective of the camera performing face recognition. For example, the response signal parameters can include noise signal parameters, which can be adapted to the characteristics of the incident light. As noted above, the signal parameters of the visible light captured by the outward facing camera and the characteristics (e.g., illumination) of the user's face can be used to determine parameters of response signals that will be projected onto the target landmarks.

Each feature or landmark on the face can be characterized in terms of illumination (or brightness) level, contrast level, temperature level, and/or other characteristic. For example, once the face is registered, the counter recognition system 200 can determine how well illuminated each landmark is based on the illumination determined from the frames captured by the inward facing camera. The illumination of a response signal that is to directed to a particular landmark can be set to be the same as or similar to the illumination determined for that landmark on the user's face. The characteristics of the incident light can also set a threshold for the parameters of the response signals. For example, if there are blinds through which light is shining and that is causing a pattern of straight lines to be projected on the viewer's face, depending on the contrast in light that is observed, the parameters of the response signal need to lie within that noise threshold.

At block 834, the process 809 includes transmitting the response signals to the target landmarks. For example, the response signals can be projected onto certain target face landmarks on the face of the user 732 in order to mask the facial features of the user 732 from being recognized by the camera 730. In some examples, the coded structured light projector can be configured to adaptively add a light pattern introducing noise to landmark regions of the face of the user 732. In some implementations, an IR flood illuminator or a pulsed IR flood illuminator can direct IR or NIR signals onto the targeted face landmarks. In some cases, pattern modulation can be performed by the IR illuminator of the wearable device 704 in order to project a pattern of IR or NIR signals on the face of the user 732. For instance, IR signals or dot patterns can be projected onto the face landmarks by the IR illuminator.

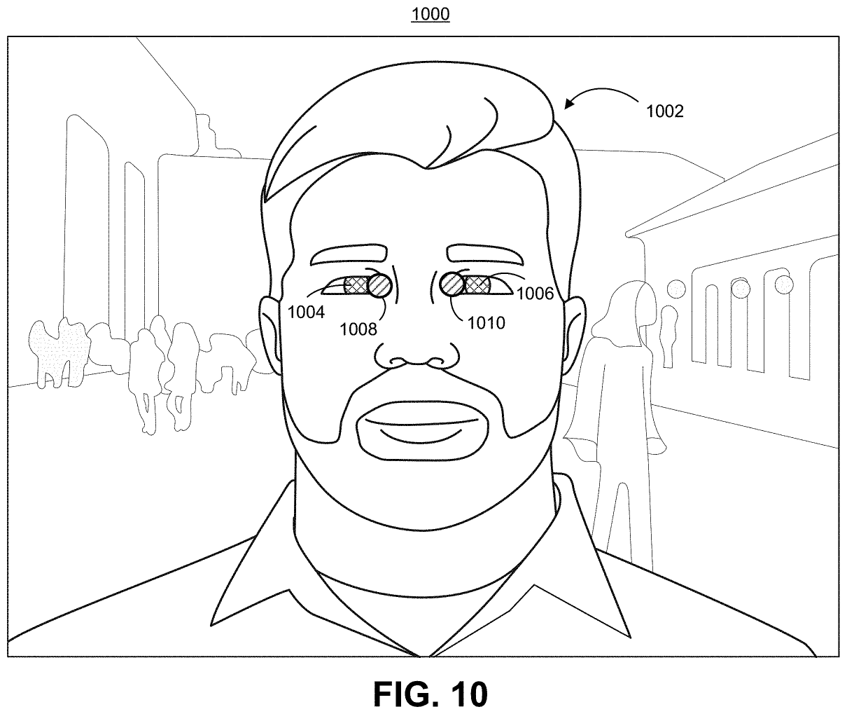

The transmitted response signals include the response signal parameters determined at block 832. The response signals are transmitted in order to add noise to the face, so that face recognition is disrupted. A response signal will be projected to a position on the user's face that is close to, but offset from, the landmark that the response signal is targeting. FIG. 10 is an image 1000 of a face of a person 1002. Response signals 1008 and 1010 are projected next to the eyes 1004 and 1006 of the person 1002, which correspond to the inter-eye distance (Rank 1) shown in FIG. 9C. As shown, the response signals 1008 and 1010 are projected as being offset from the eyes 1004 and 1006, causing the eyes 1004 and 1006 to look displaced or to look larger than they actually are. Further, the luminance (or brightness) of the response signals 1008 and 1010 are set so that they match the luminance of the eyes as detected from the frame captured by the inward facing camera. Matching the luminance of the response signals 1008 and 1010 with the luminance of the eyes 1004 and 1006 allows there to not be a sharp contrast between the projected response signals 1008 and 1010 with the luminance of the eyes 1004 and 1006. Such distortion of the inter-eye distance causes disruption of face recognition by a face recognition algorithm. For example, the face recognition algorithm of the camera will be unable to determine where the central point of the pupil is located, and thus will not be able to determine the inter-eye distance.

In another example, the incident signal parameters detection engine 208 can determine the pattern of incident light on the user's face. The pattern of the incident light can be used by the response signal parameters determination engine 210 to determine a pattern of a response signal. In one illustrative example, if light is shining through a set of blinds, the incident signal parameters detection engine 208 can determine the pattern of the incident light on the user's face includes multiple straight lines. The response signal parameters determination engine 210 can cause a light source to project light having the same pattern with a luminance that matches the incident light onto a face landmark. By matching the pattern, a sharp contrast between the actual incident light and the projected light on the face landmark is avoided.

In some examples, the response signals (also referred to as interference signals) can be randomized across the groups of landmarks, with varying levels additive noise. For example, the light source of the counter recognition system 200 can project visible light signals on the landmarks in the Rank 1 group and in the Rank 3 group for a first duration of time, project visible light signals on the landmarks in the Rank 1 group and in the Rank 2 group for a second duration of time, project visible light signals on the landmarks in the Rank 2 group and in the Rank 3 group for a third duration of time, and so on. In some examples, the coded structured light projector can be programmed to randomly target the different groups of landmarks. The randomization of the projected light can be performed so that over a period of time the projected light is not apparent in a video sequence captured by the camera performing the face recognition.

A camera performing object recognition using color images (e.g., RGB images) will capture as many images as possible and attempt to analyze the images to recognize an object. There may be a delay period between when the camera begins capturing image frames of the object and when the light signals can be projected onto the landmarks. However, the response signals can be emitted before the camera has enough time to obtain enough information to complete the face recognition. For instance, it may take at least four frames for the camera to collect enough descriptor information to perform color image (e.g., RGB image) based object recognition. At 30 frames per second, four frames occur in approximately 133 milliseconds. The jamming counter recognition can be performed in enough time (e.g., 100 milliseconds or 10 frames per second, or other time rate or frame rate) to counter at least one of the four frames, which prevents the facial recognition from being performed.

In some implementations, the masking counter recognition technique can be based on incident IR signals in addition to or as an alternative to visible light. For example, parameters of the IR response signal can be determined based on the signals detected by the IR camera. For example, the response signal determination engine 210 can determine parameters of the response signal to counter the IR signals that are incident on target landmark. For example, similar to the jamming counter recognition technique, a response IR signal that is projected onto a target landmark can have the same amplitude and frequency as the incident signal, but with an inverse phase.

Based on the masking counter recognition technique, the IR signals and/or the visible light patterns mask the face landmarks, effectively distorting face recognition from being performed by a camera. The effect of the adaptive masking technique on the camera is a different contrast in face landmark regions, which when randomized provides the needed masking.

The wearable device with the counter recognition system 200 can perform the counter recognition techniques indoors or outdoors. For example, a pattern modulator (e.g., implemented by the coded structured light projector) can adapt to ambient light conditions, and the IR illuminator can be used for pattern modulation in dark/low light conditions.

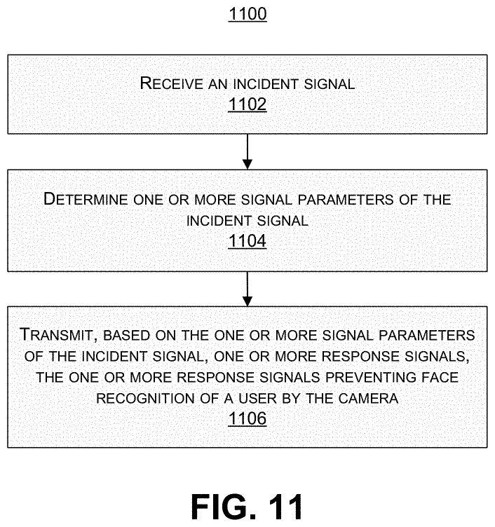

FIG. 11 is a flowchart illustrating an example of a process 1100 of preventing face recognition by a camera using one or more of the counter recognition techniques described herein. At block 1102, the process 1100 includes receiving an incident signal by a user device. In some cases, block 1102 can include detecting an incident signal. The device can include any suitable device, such as a wearable device, a mobile device (e.g., a mobile phone or smart phone, a tablet device, or the like), any other device, or any combination thereof. In some cases, the device can include a camera for capturing one or more images (e.g., the camera can receive an incident signal including an RGB image signal or other suitable image signal), an infrared camera that can detect infrared or near-infrared signals, a signal emitter for emitting one or more signals (e.g., an infrared illuminator for emitting one or more infrared signals, or other suitable signal emitting device), a structured light illuminator, any combination thereof, or other suitable component. In some aspects, the apparatus further includes a display for displaying one or more images, notifications, or other displayable data. In some examples, the incident signal is from the camera. For example, the camera can transmit signals in an environment in which the device is located. One or more of the transmitted signals can become incident on the device, which the device can detect (including the incident signal).

At block 1104, the process 1100 includes determining one or more signal parameters of the incident signal. In some examples, the one or more signal parameters can include an amplitude, a frequency, and a phase of the incident signal. In some examples, the one or more signal parameters can include a contrast, a color temperature, a brightness, a number of lumens, and/or a light pattern of the incident signal.

At block 1106, the process 1100 includes transmitting, based on the one or more signal parameters of the incident signal, one or more response signals. The one or more response signals prevent face recognition of the user by the camera, as described above.

In some aspects, the process 1100 includes determining whether the incident signal is a first type of signal or a second type of signal. In some cases, the first type of signal includes an infrared signal, and the second type of signal includes a visible light spectrum signal having one or more characteristics. In some cases, the first type of signal includes a near-infrared signal, and the second type of signal includes a visible light spectrum signal having one or more characteristics. In some cases, the first type of signal includes an infrared signal, and the second type of signal includes a near-infrared signal.

In some cases, transmitting the one or more response signals includes transmitting the one or more response signals in a direction towards the camera, such as using the jamming counter recognition technique described above. In some cases, the one or more response signals are transmitted in the direction towards the camera when the incident signal is determined to be the first type of signal (e.g., an infrared signal or a near-infrared signal).

In one illustrative example, the process 1100 includes detecting the incident signal, and estimating one or more inverse signal parameters associated with the one or more signal parameters of the incident signal. In some cases, the incident signal can include an infrared signal or a near-infrared signal. The one or more signal parameters can include an amplitude, a frequency, and a phase of the incident signal, and the one or more inverse signal parameters can include at least a fraction of the amplitude, the frequency, and an inverse of the phase. For instance, as described above, the amplitude of a response signal can be within a certain threshold different from the amplitude of a corresponding incident signal (so that the amplitude of the response signal is close enough to the amplitude of the incident signal to provide enough cancellation between the signals so that object recognition cannot be accurately performed), and the phase of the response signal can be the inverse of the phase of the incident signal. The threshold difference can be based on a percentage or fraction, such as 100% (the amplitudes are the same), 50% (the amplitude of the response signal is 50% of the amplitude of the incident signal), or other suitable amount. In such an illustrative example, transmitting, based on the one or more signal parameters of the incident signal, the one or more response signals can include transmitting, towards the camera (e.g., in the direction towards the camera), at least one inverse signal having the one or more inverse signal parameters. Based on the inverse phase, the at least one inverse signal at least partially cancels out one or more incident signals. In some cases, the one or more inverse signal parameters are determined and the one or more response signals are transmitted towards the camera when the incident signal is determined to be the first type of signal (e.g., an infrared signal or a near-infrared signal).

In some cases, transmitting the one or more response signals includes projecting the one or more response signals to one or more face landmarks of the user, such as using the masking counter recognition technique described above. In some cases, the one or more response signals are projected to the one or more face landmarks of the user when the incident signal is determined to be the second type of signal (e.g., a near-infrared signal or a visible light spectrum signal having one or more characteristics).

In one illustrative example, the process 1100 includes estimating one or more noise signal parameters based on the one or more signal parameters of the incident signal. In some cases, the incident signal can include a visible light signal (e.g., an image, a signal indicating the ambient light surrounding the device, or other visible light signal) or a near-infrared signal. In such an example, transmitting, based on the one or more signal parameters of the incident signal, the one or more response signals includes projecting one or more noise signals having the one or more noise signal parameters to one or more face landmarks of the user. The one or more noise signal parameters can include a contrast, a color temperature, a brightness, a number of lumens, a light pattern, any combination thereof, and/or other suitable parameters. The one or more noise signal parameters cause the one or more noise signals to match one or more characteristics of the one or more face landmarks of the user. In some cases, the one or more noise signal parameters are estimated and the one or more noise signals are projected to the one or more face landmarks of the user when the incident signal is determined to be the second type of signal (e.g., a near-infrared signal or a visible light spectrum signal having one or more characteristics).

In some cases, the incident signal can include an image signal (e.g., an RGB image signal or other signal). In such cases, the process 1100 can detect whether a camera (e.g., a security camera) form factor is in a received image. If a camera is detected in the image, the jamming counter recognition technique described above (e.g., transmitting the one or more response signals in a direction towards the camera) and/or the masking counter recognition technique described above (e.g., projecting the one or more response signals to one or more face landmarks of the user) can be performed.

In some aspects, the process 1100 includes providing an indication to the user that face recognition was attempted. For example, a visual, audible, and/or other type of notification can be provided using a display, a speaker, and/or other output device. In one illustrative example, a visual notification can be displayed on a display of augmented reality (AR) glasses. In some cases, one or more icons or other visual item can be displayed when it is determined that face recognition (or other object recognition) has been attempted. One icon or other visual item can provide an option to opt into the face recognition, and another icon or other visual item can provide an option to counter the face recognition. The user can select the icon or other visual item (e.g., by pressing a physical button, a virtual button, providing a gesture command, providing an audio command, etc.) providing the option the user prefers. The selected option can be stored as a preference in some examples. For example, at a future time, when it is determined that face recognition is being attempted again, the stored preference can be used to automatically performed the corresponding function (e.g., allow the face recognition and/or cease performance of the one or more counter recognition techniques). In one illustrative example, the process 1100 can include receiving input from a user indicating a preference to approve performance of the face recognition. In response to receiving the input from the user indicating the preference to approve the performance of the face recognition, the process 1100 can stop or cease from transmitting the one or more response signals. In some examples, the process 1100 includes saving the preference to approve the performance of the face recognition. In another illustrative example, the process 1100 can include receiving input from a user indicating a preference to counter performance of the face recognition. In response to receiving the input from the user indicating the preference to counter the performance of the face recognition, the process 1100 can determine to continue transmitting the one or more response signals.

In some examples, the process 1100 may be performed by a computing device or an apparatus, which can include the counter recognition system 200 shown in FIG. 2. In some cases, the computing device or apparatus may include a processor, microprocessor, microcomputer, or other component of a device that is configured to carry out the steps of process 1100. In some examples, the computing device or apparatus may include one or more components, such as a camera for capturing one or more images, an infrared camera that can detect infrared or near-infrared signals, a signal emitter for emitting one or more signals (e.g., an infrared illuminator for emitting one or more infrared signals, or other suitable signal emitting device), a structured light illuminator, any combination thereof, or other suitable component. For example, the computing device may include a wearable device, a mobile device, or other device with the one or more components. In some cases, the computing device may include a display for displaying one or more images, notifications, or other displayable data. In some cases, the computing device may include a video codec. In some examples, some of the one or more components can be separate from the computing device, in which case the computing device receives the data or transmits the data. The computing device may further include a network interface configured to communicate data. The network interface may be configured to communicate Internet Protocol (IP) based data or other suitable network data.

Process 1100 is illustrated as a logical flow diagram, the operation of which represents a sequence of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

Additionally, the process 1100 may be performed under the control of one or more computer systems configured with executable instructions and may be implemented as code (e.g., executable instructions, one or more computer programs, or one or more applications) executing collectively on one or more processors, by hardware, or combinations thereof. As noted above, the code may be stored on a computer-readable or machine-readable storage medium, for example, in the form of a computer program comprising a plurality of instructions executable by one or more processors. The computer-readable or machine-readable storage medium may be non-transitory.

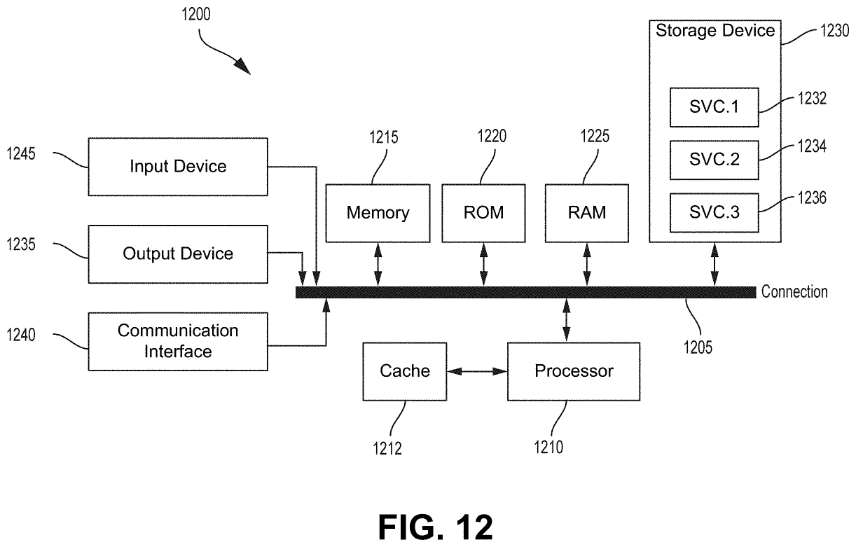

FIG. 12 illustrates an example computing device architecture 1200 of an example computing device which can implement the various techniques described herein. For example, a computing device with the computing device architecture 1200 can implement the counter recognition system 200 shown in FIG. 2 and perform the counter recognition techniques described herein. The components of computing device architecture 1200 are shown in electrical communication with each other using connection 1205, such as a bus. The example computing device architecture 1200 includes a processing unit (CPU or processor) 1210 and computing device connection 1205 that couples various computing device components including computing device memory 1215, such as read only memory (ROM) 1220 and random access memory (RAM) 1225, to processor 1210.

Computing device architecture 1200 can include a cache of high-speed memory connected directly with, in close proximity to, or integrated as part of processor 1210. Computing device architecture 1200 can copy data from memory 1215 and/or the storage device 1230 to cache 1212 for quick access by processor 1210. In this way, the cache can provide a performance boost that avoids processor 1210 delays while waiting for data. These and other modules can control or be configured to control processor 1210 to perform various actions. Other computing device memory 1215 may be available for use as well. Memory 1215 can include multiple different types of memory with different performance characteristics. Processor 1210 can include any general purpose processor and a hardware or software service, such as service 1 1232, service 2 1234, and service 3 1236 stored in storage device 1230, configured to control processor 1210 as well as a special-purpose processor where software instructions are incorporated into the processor design. Processor 1210 may be a self-contained system, containing multiple cores or processors, a bus, memory controller, cache, etc. A multi-core processor may be symmetric or asymmetric.

To enable user interaction with the computing device architecture 1200, input device 1245 can represent any number of input mechanisms, such as a microphone for speech, a touch-sensitive screen for gesture or graphical input, keyboard, mouse, motion input, speech and so forth. Output device 1235 can also be one or more of a number of output mechanisms known to those of skill in the art, such as a display, projector, television, speaker device, etc. In some instances, multimodal computing devices can enable a user to provide multiple types of input to communicate with computing device architecture 1200. Communications interface 1240 can generally govern and manage the user input and computing device output. There is no restriction on operating on any particular hardware arrangement and therefore the basic features here may easily be substituted for improved hardware or firmware arrangements as they are developed.

Storage device 1230 is a non-volatile memory and can be a hard disk or other types of computer readable media which can store data that are accessible by a computer, such as magnetic cassettes, flash memory cards, solid state memory devices, digital versatile disks, cartridges, random access memories (RAMs) 1225, read only memory (ROM) 1220, and hybrids thereof. Storage device 1230 can include services 1232, 1234, 1236 for controlling processor 1210. Other hardware or software modules are contemplated. Storage device 1230 can be connected to the computing device connection 1205. In one aspect, a hardware module that performs a particular function can include the software component stored in a computer-readable medium in connection with the necessary hardware components, such as processor 1210, connection 1205, output device 1235, and so forth, to carry out the function.

For clarity of explanation, in some instances the present technology may be presented as including individual functional blocks including functional blocks comprising devices, device components, steps or routines in a method embodied in software, or combinations of hardware and software.

In some embodiments the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods and processes according to the above-described examples can be implemented using computer-executable instructions that are stored or otherwise available from computer readable media. Such instructions can include, for example, instructions and data which cause or otherwise configure a general purpose computer, special purpose computer, or a processing device to perform a certain function or group of functions. Portions of computer resources used can be accessible over a network. The computer executable instructions may be, for example, binaries, intermediate format instructions such as assembly language, firmware, source code, etc. Examples of computer-readable media that may be used to store instructions, information used, and/or information created during methods according to described examples include magnetic or optical disks, flash memory, USB devices provided with non-volatile memory, networked storage devices, and so on.

Devices implementing methods according to these disclosures can include hardware, firmware and/or software, and can take any of a variety of form factors. Typical examples of such form factors include laptops, smart phones, small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

In the foregoing description, aspects of the application are described with reference to specific embodiments thereof, but those skilled in the art will recognize that the application is not limited thereto. Thus, while illustrative embodiments of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, embodiments can be utilized in any number of environments and applications beyond those described herein without departing from the broader spirit and scope of the specification. The specification and drawings are, accordingly, to be regarded as illustrative rather than restrictive. For the purposes of illustration, methods were described in a particular order. It should be appreciated that in alternate embodiments, the methods may be performed in a different order than that described.

One of ordinary skill will appreciate that the less than (“<”) and greater than (“>”) symbols or terminology used herein can be replaced with less than or equal to (“≤”) and greater than or equal to (“≥”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set indicates that one member of the set or multiple members of the set satisfy the claim. For example, claim language reciting “at least one of A and B” means A, B, or A and B.

The various illustrative logical blocks, modules, circuits, and algorithm steps described in connection with the embodiments disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein. In addition, in some aspects, the functionality described herein may be provided within dedicated software modules or hardware modules configured for encoding and decoding, or incorporated in a combined video encoder-decoder (CODEC).

1. An apparatus for preventing face recognition from being performed, comprising:
a memory; and
a processor coupled to the memory and configured to:
receive an incident signal;
determine one or more signal parameters of the incident signal;
generate, based on the one or more signal parameters of the incident signal, one or more response signals; and
transmit the one or more response signals, the one or more response signals disrupting performance of face recognition of a user.

2. The apparatus of claim 1, wherein the incident signal is from a device including one or more cameras.

3. The apparatus of claim 1, wherein transmitting the one or more response signals includes transmitting the one or more response signals in a direction towards a device including one or more cameras.

4. The apparatus of claim 1, wherein transmitting the one or more response signals includes projecting the one or more response signals to one or more face landmarks of the user.

5. The apparatus of claim 1, wherein the processor is configured to:
detect the incident signal; and
estimate one or more inverse signal parameters associated with the one or more signal parameters of the incident signal,
wherein transmitting, based on the one or more signal parameters of the incident signal, the one or more response signals includes transmitting, towards a device including one or more cameras, at least one inverse signal having the one or more inverse signal parameters, the at least one inverse signal at least partially canceling out one or more incident signals.

6. The apparatus of claim 5, wherein the one or more signal parameters include an amplitude, a frequency, and a phase of the incident signal, and wherein the one or more inverse signal parameters include at least a fraction of the amplitude, the frequency, and an inverse of the phase.

7. The apparatus of claim 1, wherein the processor is configured to:
estimate one or more noise signal parameters based on the one or more signal parameters of the incident signal; and
wherein transmitting, based on the one or more signal parameters of the incident signal, the one or more response signals includes projecting one or more noise signals having the one or more noise signal parameters to one or more face landmarks of the user, the one or more noise signal parameters causing the one or more noise signals to match one or more characteristics of the one or more face landmarks of the user.

8. The apparatus of claim 7, wherein the one or more noise signal parameters include at least one of a contrast, a color temperature, a brightness, a number of lumens, or a light pattern.

9. The apparatus of claim 1, wherein the processor is configured to determine whether the incident signal is a first type of signal or a second type of signal.

10. The apparatus of claim 9, wherein the first type of signal includes an infrared signal, and wherein the second type of signal includes a visible light spectrum signal having one or more characteristics.

11. The apparatus of claim 9, wherein the first type of signal includes a near-infrared signal, and wherein the second type of signal includes a visible light spectrum signal having one or more characteristics.

12. The apparatus of claim 9, wherein the first type of signal includes an infrared signal, and wherein the second type of signal includes a near-infrared signal.

13. The apparatus of claim 9, wherein transmitting, based on the one or more signal parameters of the incident signal, the one or more response signals includes:
transmitting the one or more response signals in a direction towards a device including one or more cameras when the incident signal is determined to be the first type of signal.

14. The apparatus of claim 13, wherein the processor is configured to:
estimate one or more inverse signal parameters associated with the one or more signal parameters of the incident signal; and
wherein transmitting, based on the one or more signal parameters of the incident signal, the one or more response signals includes transmitting, towards the device including the one or more cameras, at least one inverse signal having the one or more inverse signal parameters, the at least one inverse signal at least partially canceling out one or more incident signals.

15. The apparatus of claim 9, wherein transmitting, based on the one or more signal parameters of the incident signal, the one or more response signals includes:
projecting the one or more response signals to one or more face landmarks of the user when the incident signal is determined to be the second type of signal.

16. The apparatus of claim 9, wherein the processor is configured to:
estimate one or more noise signal parameters based on the one or more signal parameters of the incident signal; and
wherein transmitting, based on the one or more signal parameters of the incident signal, the one or more response signals includes projecting one or more noise signals having the one or more noise signal parameters to one or more face landmarks of the user, the one or more noise signal parameters causing the one or more noise signals to match one or more characteristics of the one or more face landmarks of the user.

17. The apparatus of claim 16, wherein the one or more noise signal parameters include at least one of a contrast, a color temperature, a brightness, a number of lumens, or a light pattern.

18. The apparatus of claim 1, wherein the processor is configured to provide an indication to the user that face recognition was attempted.

19. The apparatus of claim 18, wherein the processor is configured to:
receive input from the user indicating a preference to approve performance of the face recognition; and
cease from transmitting the one or more response signals in response to receiving the input.

20. The apparatus of claim 19, wherein the processor is configured to save the preference.

21. The apparatus of claim 1, wherein the apparatus comprises a wearable device.

22. The apparatus of claim 1, further comprising at least one of a camera for capturing one or more images, an infrared camera, or an infrared illuminator.

23. The apparatus of claim 1, further comprising a display for displaying one or more images.

24. A method of preventing face recognition from being performed, the method comprising:
receiving, by a user device, an incident signal;
determining one or more signal parameters of the incident signal;
generating based on the one or more signal parameters of the incident signal, one or more response signals; and
transmitting the one or more response signals, the one or more response signals disrupting performance of face recognition of a user.

25. The method of claim 24, wherein transmitting the one or more response signals includes transmitting the one or more response signals in a direction towards a device including one or more cameras.

26. The method of claim 24, wherein transmitting, based on the one or more signal parameters of the incident signal, the one or more response signals includes projecting the one or more response signals to one or more face landmarks of the user.

27. The method of claim 24, further comprising:
detecting the incident signal; and
estimating one or more inverse signal parameters associated with the one or more signal parameters of the incident signal,
wherein transmitting, based on the one or more signal parameters of the incident signal, the one or more response signals includes transmitting, towards a device including one or more cameras, at least one inverse signal having the one or more inverse signal parameters, the at least one inverse signal at least partially canceling out one or more incident signals.

28. The method of claim 24, further comprising:
estimating one or more noise signal parameters based on the one or more signal parameters of the incident signal; and
wherein transmitting, based on the one or more signal parameters of the incident signal, the one or more response signals includes projecting one or more noise signals having the one or more noise signal parameters to one or more face landmarks of the user, the one or more noise signal parameters causing the one or more noise signals to match one or more characteristics of the one or more face landmarks of the user.

29. The method of claim 24, wherein transmitting, based on the one or more signal parameters of the incident signal, the one or more response signals includes:
transmitting the one or more response signals in a direction towards a device including one or more cameras when the incident signal is determined to be an infrared signal or a near-infrared signal.

30. The method of claim 24, wherein transmitting, based on the one or more signal parameters of the incident signal, the one or more response signals includes:
projecting the one or more response signals to one or more face landmarks of the user when the incident signal is determined to be a visible light spectrum signal having one or more characteristics or a near-infrared signal.
